(19) United States
(12) Patent Application Publication
(10) Pub. No.: US 2026/0040066 A1
(43) Pub. Date: Feb. 5, 2026

(54) KEYS FROM WIRELESS CHANNEL IN CELLULAR SYSTEM NON-ACCESS STRATUM LAYER

(71) Applicant: Apple Inc., Cupertino, CA (US)

(72) Inventors: Shu Guo, Beijing (CN); Huarui Liang, Beijing (CN); Dawei Zhang, Saratoga, CA (US); Haitong Sun, Saratoga, CA (US); Chunxuan Ye, San Diego, CA (US); Haijing Hu, Los Gatos, CA (US); Wei Zeng, Saratoga, CA (US)

(73) Assignee: Apple Inc., Cupertino, CA (US)

(21) Appl. No.: 19/043,346

(22) Filed: Jan. 31, 2025

Related U.S. Application Data
(60) Provisional application No. 63/678,781, filed on Aug. 2, 2024.

(51) Int. Cl. H04W 12/0433; H04W 12/041

(52) U.S. Cl. CPC H04W 12/0433; H04W 12/041

(57) ABSTRACT

The present application relates to devices and components including apparatus, systems, and methods to provide configuration of enhanced physical layer security key generation.

### CROSS-REFERENCE TO RELATED APPLICATION

This application claims the benefit of U.S. Provisional Patent Application No. 63/678,781, filed Aug. 2, 2024, which is herein incorporated by reference in its entirety for all purposes.

### TECHNICAL FIELD

The present application relates to the field of wireless technologies and, in particular, to physical layer security-key enhancement for generation of physical layer security keys.

### BACKGROUND

Third Generation Partnership Project (3GPP) networks utilizes keys for authentication and determining authorization for communications among devices of the networks. In particular, keys are generated for user equipments (UEs) that are used for determining whether the UEs are allowed to access the network and/or which portions of the network the UEs are allowed to access. The networks attempt to protect these keys against unauthorized obtainment and use by unauthorized users.

### BRIEF DESCRIPTION OF THE DRAWINGS

FIG. 1 illustrates a network environment in accordance with some embodiments.

FIG. 2 illustrates a user equipment (UE) in accordance with some embodiments.

FIG. 3 illustrates a network device in accordance with some embodiments.

FIG. 4 illustrates an example key hierarchy generation arrangement in accordance with some embodiments.

FIG. 5 illustrates an example non-access stratum (NAS) security mode command procedure in accordance with some embodiments.

FIG. 6 illustrates a first portion of a NAS key derivation procedure in accordance with some embodiments.

FIG. 7 illustrates a second portion of the NAS key derivation procedure in accordance with some embodiments.

FIG. 8 illustrates an example NAS security mode command procedure in accordance with some embodiments.

FIG. 9 illustrates an example physical layer security (PLS) key enhancement preference information element (IE) in accordance with some embodiments.

FIG. 10 illustrates an example procedure of generating physical layer secret keys in cellular system in accordance with some embodiments.

FIG. 11 illustrates an example procedure for PLS key enhancement in accordance with some embodiments.

FIG. 12 illustrates an example procedure for PLS key enhancement in accordance with some embodiments.

FIG. 13 illustrates an example procedure for key generation in accordance with some embodiments.

FIG. 14 illustrates an example procedure for encryption based on elliptic curve integrated encryption scheme (ECIES) at a UE in accordance with some embodiments.

FIG. 15 illustrates an example procedure for decryption based on ECIES at a home network in accordance with some embodiments.

FIG. 16 illustrates an example subscription concealed identifier (SUCI) arrangement in accordance with some embodiments.

FIG. 17 illustrates an example SUCI profile A representation in accordance with some embodiments.

FIG. 18 illustrates an example SUCI profile B representation in accordance with some embodiments.

FIG. 19 illustrates an example procedure for initiation of authentication procedure and selection of authentication method in accordance with some embodiments.

FIG. 20 illustrates a first portion of an example procedure representation for an approach related to SUCI enhancement in accordance with some embodiments.

FIG. 21 illustrates a second portion of the example procedure representation for the approach related to SUCI enhancement in accordance with some embodiments.

FIG. 22 illustrates a first portion of an example primary authentication procedure representation for fifth generation (5G) authentication and key agreement (AKA) in accordance with some embodiments.

FIG. 23 illustrates a second portion of the example primary authentication procedure representation for 5G AKA in accordance with some embodiments.

FIG. 24 illustrates an example procedure for generating a registration request in accordance with some embodiments.

FIG. 25 illustrates an example procedure for implementing a SUCI enhancement in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

Legacy approaches for generating non-access stratum (NAS) keys within a network utilize a symmetric key preconfigured in a universal subscriber identity module (USIM) to generate a NAS key. When the USIM is compromised and/or the database of USIM card vendors are compromised, the NAS keys are no longer secure.

Approaches described herein can address this issue by facilitating perfect forward secrecy (PFS) where both the symmetric key and physical layer channel information can be utilized for deriving the NAS keys. For example, a network and a UE may exchange communications for determining whether a physical layer security (PLS)-key enhancement is to be utilized for the UE and/or providing information for performance of the PLS-key enhancement. Errors may occur if the network and the UE are not in agreement regarding whether the PLS-key enhancement is to be utilized and/or the information for performance of the PLS-key enhancement.

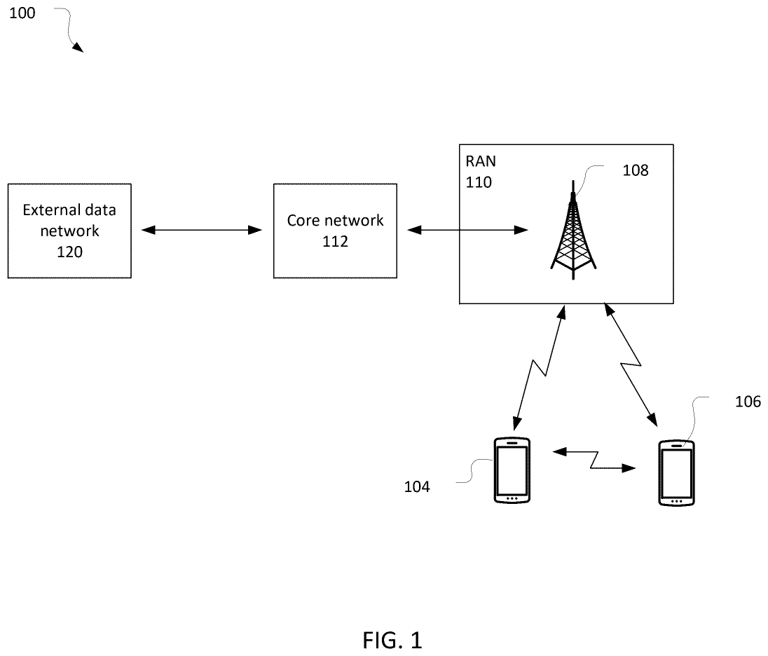

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5^{th} Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

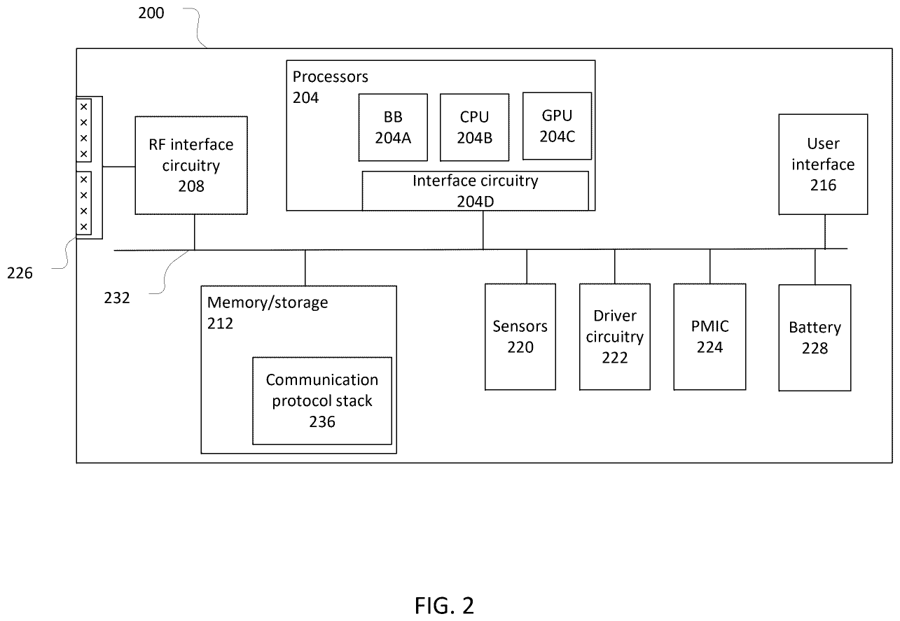

FIG. 2 illustrates a UE 200 in accordance with some embodiments. The UE 200 may be similar to and substantially interchangeable with UE 104 or 106.

The UE 200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 200 may include processors 204, RF interface circuitry 208, memory/storage 212, user interface 216, sensors 220, driver circuitry 222, power management integrated circuit (PMIC) 224, antenna 226, and battery 228. The components of the UE 200 may be implemented as integrated circuits (ICs), portions thereof, discrete electronic devices, or other modules, logic, hardware, software, firmware, or a combination thereof. The block diagram of FIG. 2 is intended to show a high-level view of some of the components of the UE 200. However, some of the components shown may be omitted, additional components may be present, and different arrangement of the components shown may occur in other implementations.

The components of the UE 200 may be coupled with various other components over one or more interconnects 232, which may represent any type of interface, input/output, bus (local, system, or expansion), transmission line, trace, or optical connection that allows various circuit components (on common or different chips or chipsets) to interact with one another.

The processors 204 may include processor circuitry such as, for example, baseband processor circuitry (BB) 204A, central processor unit circuitry (CPU) 204B, and graphics processor unit circuitry (GPU) 204C. The processors 204 may include any type of circuitry or processor circuitry that executes or otherwise operates computer-executable instructions, such as program code, software modules, or functional processes from memory/storage 212 to cause the UE 200 to perform delay-adaptive operations as described herein. The processors 204 may also include interface circuitry 204D to communicatively couple the processor circuitry with one or more other components of the UE 200.

In some embodiments, the baseband processor circuitry 204A may access a communication protocol stack 236 in the memory/storage 212 to communicate over a 3GPP compatible network. In general, the baseband processor circuitry 204A may access the communication protocol stack 236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 208.

The baseband processor circuitry 204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 212 may include one or more non-transitory, computer-readable media that includes instructions (for example, communication protocol stack 236) that may be executed by one or more of the processors 204 to cause the UE 200 to perform various delay-adaptive operations described herein.

The memory/storage 212 includes any type of volatile or non-volatile memory that may be distributed throughout the UE 200. In some embodiments, some of the memory/storage 212 may be located on the processors 204 themselves (for example, memory/storage 212 may be part of a chipset that corresponds to the baseband processor circuitry 204A), while other memory/storage 212 is external to the processors 204 but accessible thereto via a memory interface. The memory/storage 212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 208 may include transceiver circuitry and a radio frequency front module (RFEM) that allows the UE 200 to communicate with other devices over a radio access network. The RF interface circuitry 208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 226 and proceed to filter and amplify (with a low-noise amplifier) the signal. The signal may be provided to a receiver of the transceiver that down-converts the RF signal into a baseband signal that is provided to the baseband processor of the processors 204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 226.

In various embodiments, the RF interface circuitry 208 may be configured to transmit/receive signals in a manner compatible with NR access technologies.

The antenna 226 may include antenna elements to convert electrical signals into radio waves to travel through the air and to convert received radio waves into electrical signals. The antenna elements may be arranged into one or more antenna panels. The antenna 226 may have antenna panels that are omnidirectional, directional, or a combination thereof to enable beamforming and multiple input, multiple output communications. The antenna 226 may include microstrip antennas, printed antennas fabricated on the surface of one or more printed circuit boards, patch antennas, or phased array antennas. The antenna 226 may have one or more panels designed for specific frequency bands including bands in FR1 or FR2.

The user interface 216 includes various input/output (I/O) devices designed to enable user interaction with the UE 200. The user interface 216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 200.

The sensors 220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 222 may include software and hardware elements that operate to control particular devices that are embedded in the UE 200, attached to the UE 200, or otherwise communicatively coupled with the UE 200. The driver circuitry 222 may include individual drivers allowing other components to interact with or control various input/output (I/O) devices that may be present within, or connected to, the UE 200. For example, driver circuitry 222 may include a display driver to control and allow access to a display device, a touchscreen driver to control and allow access to a touchscreen interface, sensor drivers to obtain sensor readings of sensors 220 and control and allow access to sensors 220, drivers to obtain actuator positions of electro-mechanic components or control and allow access to the electro-mechanic components, a camera driver to control and allow access to an embedded image capture device, audio drivers to control and allow access to one or more audio devices.

The PMIC 224 may manage power provided to various components of the UE 200. In particular, with respect to the processors 204, the PMIC 224 may control power-source selection, voltage scaling, battery charging, or DC-to-DC conversion.

A battery 228 may power the UE 200, although in some examples the UE 200 may be mounted deployed in a fixed location and may have a power supply coupled to an electrical grid. The battery 228 may be a lithium ion battery, a metal-air battery, such as a zinc-air battery, an aluminum-air battery, a lithium-air battery, and the like. In some implementations, such as in vehicle-based applications, the battery 228 may be a typical lead-acid automotive battery.

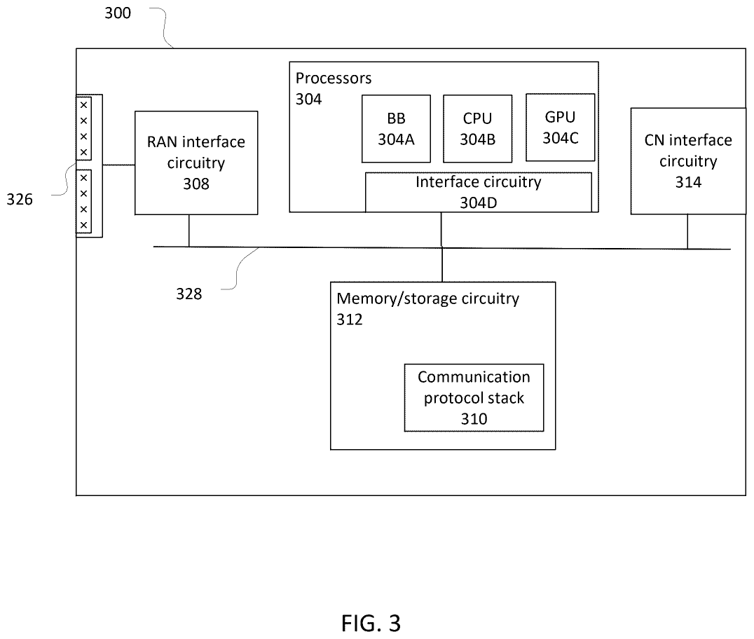

FIG. 3 illustrates a network device 300 in accordance with some embodiments. The network device 300 may be similar to and substantially interchangeable with base station 108 or a device of the core network 112 or external data network 120.

The network device 300 may include processors 304, RF interface circuitry 308 (if implemented as a base station), core network (CN) interface circuitry 314, memory/storage circuitry 312, and antenna structure 326.

The components of the network device 300 may be coupled with various other components over one or more interconnects 328.

The processors 304, RF interface circuitry 308, memory/storage circuitry 312 (including communication protocol stack 310), antenna structure 326, and interconnects 328 may be similar to like-named elements shown and described with respect to FIG. 2.

The processors 304 may include processor circuitry such as, for example, baseband processor circuitry (BB) 304A, central processor unit circuitry (CPU) 304B, and graphics processor unit circuitry (GPU) 304C. The processors 304 may include any type of circuitry or processor circuitry that executes or otherwise operates computer-executable instructions, such as program code, software modules, or functional processes from memory/storage circuitry 312 to cause the network device 300 to perform operations described herein. The processors 304 may also include interface circuitry 304D to communicatively couple the processor circuitry with one or more other components of the network device 300.

The CN interface circuitry 314 may provide connectivity to a core network, for example, a 5^{th} Generation Core network (5GC) using a 5GC-compatible network interface protocol such as carrier Ethernet protocols, or some other suitable protocol. Network connectivity may be provided to/from the network device 300 via a fiber optic or wireless backhaul. The CN interface circuitry 314 may include one or more dedicated processors or FPGAs to communicate using one or more of the aforementioned protocols. In some implementations, the CN interface circuitry 314 may include multiple controllers to provide connectivity to other networks using the same or different protocols.

A fifth generation system (5GS) implements key hierarchy generation. The keys related to authentication include K and cipher key/integrity key (CK/IK). In case of extensible authentication protocol (EAP)-authentication and key management (AKA)′, the keys CK′, IK′ are derived from CK, IK.

The key hierarchy includes a key for “Authentication Server Function” (K_{AUSE}) in home network, that is derived by CK′ and IK′. The key hierarchy further includes a K_{SEAF}: Anchor key “SEcurity Anchor Function,” which is derived by K_{AUSF}. The key hierarchy further includes a key for access and mobility management function (AMF) (K_{AMF}) in serving network, which is derived by K_{SEAF}. The key hierarchy may further include keys for NAS signaling, including K_{NASint} and K_{NASenc}. The key hierarchy may further include a key for NG-RAN (K_{gNB}), which is derived from keys for radio resource control (RRC)/User Plan traffic for encryption or integrity, including K_{RRCint}, K_{RRCenc}, K_{UPint} and K_{UPenc}. The K_{RRCint}, K_{RRCenc}, K_{UPint} and K_{UPenc} may be derived from K_{gNB}.

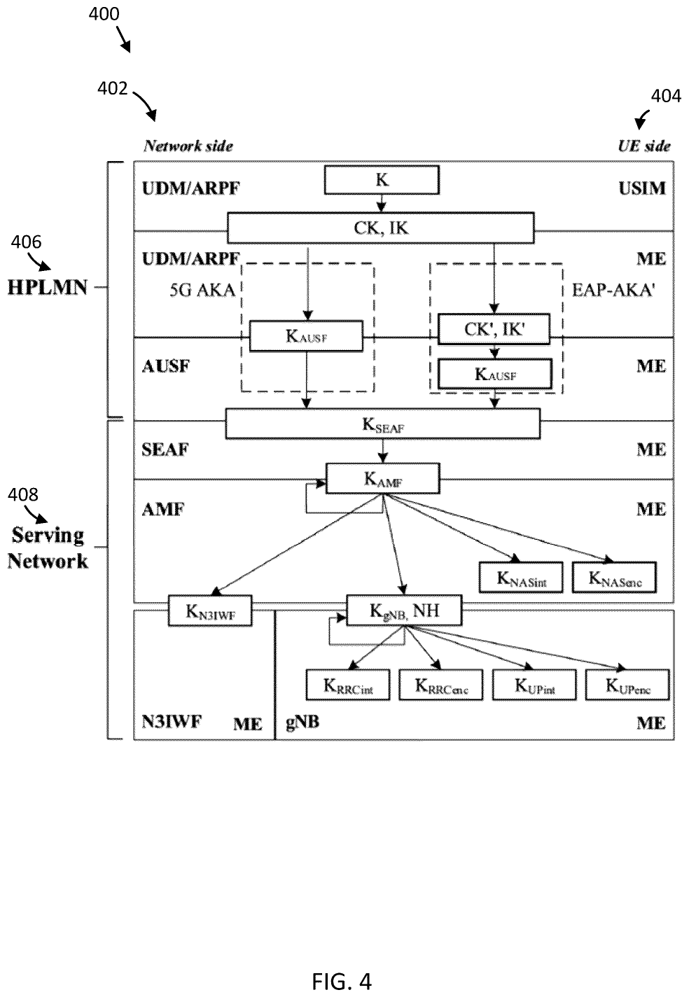

FIG. 4 illustrates an example key hierarchy generation arrangement 400 in accordance with some embodiments. The arrangement 400 illustrates keys that are generated within a network in legacy approaches.

The arrangement 400 includes a network side 402 (which corresponds to a base station and/or a core network) and a user equipment (UE) side 404 (which corresponds to a UE). The arrangement 400 further includes a home public land mobile network (HPLMN) portion 406 and a serving network portion 408. Keys illustrated in the arrangement 400 in the HPLMN portion 406 may be keys utilized between the UE and an HPLMN serving the UE. Keys illustrated in the arrangement 400 in the serving network portion 408 may be keys utilized between the UE and a serving network serving the UE.

The arrangement 400 includes a key (K). A CK and an IK is derived from the K. A K_{AUSF} is derived from the CK and the IK. Further, a K_{SEAF} is derived from the K_{AUSF}. A K_{AMF} is derived from the K_{AMF}. A K_{N3IWF}, a K_{gNB}, NH, a K_{NASint}, and a K_{NASenc} are derived from the K_{AMF}. A K_{RRCint}, a K_{RRCenc}, a K_{UPint}, and a K_{UPenc} are derived from the K_{gNB}, NH.

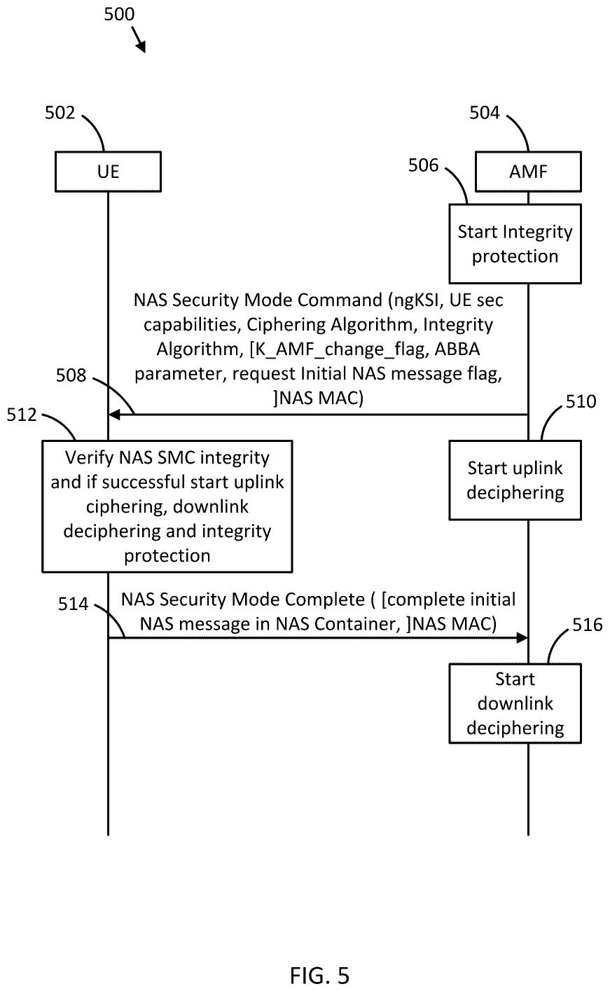

Legacy NAS layer security negotiation is illustrated in FIG. 5. In preparation for the legacy NAS layer security negotiation, the UE provides UE security capabilities in a “Registration Request” message to an AMF, so the AMF has knowledge of the UE's security capabilities.

The UE transmits to radio access network (RAN) or access network (AN), which in turn transmits to the AMF an access network (AN) message (that includes AN parameters, Registration Request (Registration type, SUCI or 5G-GUTI or PEI, [last visited TAI (if available)], Security parameters, [Requested NSSAI], [Mapping Of Requested NSSAI], [Default Configured NSSAI Indication], [UE Radio Capability Update], [UE MM Core Network Capability], [PDU Session status], [List Of PDU Sessions To Be Activated], [Follow-on request], [MICO mode preference], [Requested Active Time], [Requested DRX parameters], [extended idle mode DRX parameters], [LADN DNN(s) or Indicator Of Requesting LADN Information], [NAS message container], [Support for restriction of use of Enhanced Coverage], [Preferred Network Behavior], [UE Policy Container (the list of PSIs, indication of UE support for ANDSP and the operating system identifier)] and [UE Radio Capability ID], PEI)).

FIG. 5 illustrates an example NAS security mode command procedure 500 in accordance with some embodiments. For example, the procedure 500 illustrates operations that may be performed and/or communications that may be communicated for NAS security.

The procedure 500 includes a UE 502 and an AMF 504. The AMF 504 may communicate with the UE 502 via a base station. The procedure 500 initiates with the AMF 504 starting integrity protection in 506. For example, the AMF 504 activates the NAS integrity protection before sending the NAS Security Mode Command message.

The AMF 504 transmits a NAS security mode command message 508 to the UE. The NAS security mode command message 508 includes an ngKSI, a UE security capabilities, a ciphering algorithm, an integrity algorithm, K_AMF_change_flag, an ABBA parameter, a request initial NAS message flag, and/or a NAS MAC. For example, the AMF 504 sends the NAS Security Mode Command message to the UE 502. The NAS Security Mode Command message contains the replayed UE security capabilities, the selected NAS algorithms, and the ngKSI for identifying the K_{AMF}. The NAS Security Mode Command message may contain the K_AMF_change_flag (carried in the additional 5G security parameters IE) to indicate a new KAME is calculated, a flag requesting the complete initial NAS message, Anti-Bidding down Between Architectures (ABBA) parameter. In the case of horizontal derivation of K_{AMF} during mobility registration update or during multiple registration in same PLMN, K_AMF_change_flag shall be included in the NAS Security Mode Command message.

The procedure 500 includes the AMF 504 starting uplink deciphering in 510. For example, the AMF 504 activates the NAS uplink deciphering after sending the NAS Security Mode Command message.

The UE 502 verifies NAS security mode command (SMC) integrity and, if successful integrity verification, start uplink ciphering, downlink deciphering, and integrity protection in 512. For example, the UE 502 verifies the NAS Security Mode Command message. This includes checking that the UE security capabilities sent by the AMF 504 match the ones stored in the UE 502 to ensure that these were not modified by an attacker and verifying the integrity protection using the indicated NAS integrity algorithm and the NAS integrity key based on the K_{AMF} indicated by the ngKSI. If the verification of the integrity of the NAS Security Mode Command message is successful, the UE 502 starts NAS integrity protection and ciphering/deciphering with the security context indicated by the ngKSI.

The UE 502 transmits a NAS security mode complete message 514 to the AMF 504. The NAS security mode complete message 514 includes a complete initial NAS message in NAS container and NAS MAC. For example, the UE 502 sends the NAS Security Mode Complete message to the AMF 504 ciphered and integrity protected. The AMF 504 may start downlink deciphering in 516.

During the NAS security negotiation procedure, the UE 502 reports its capability using 5G-EA4/5/6, 5G-IA4/5/6 (it is also OK to use EEA4/5/6 and EIA4/5/6).

NAS keys are based on the symmetric key preconfigured in the universal subscriber identity module (USIM). When the USIM is compromised, or the data base of USIM card vendors is compromised, the NAS keys are not secure anymore. PFS is one way out for this vulnerability. In PFS, the UE and base station (such as a next generation NodeB (gNB)) may not only rely on the symmetric key but also may rely on the physical layer channel information to derive the NAS keys. In this case, even when the data base of the USIM card or USIM is compromised, an attacker may need to record the communication to compromise the NAS keys.

There may be no direct physical channel between a UE and an AMF, so the channel between UE and the base station may be leveraged. One AMF may manage many base station. Which channel will be used may need to be decided.

In a first approach (which may be referred to as “Approach 1”), a new NAS key derivation based on a first base station (such as a gNB) under an AMF may be introduced.

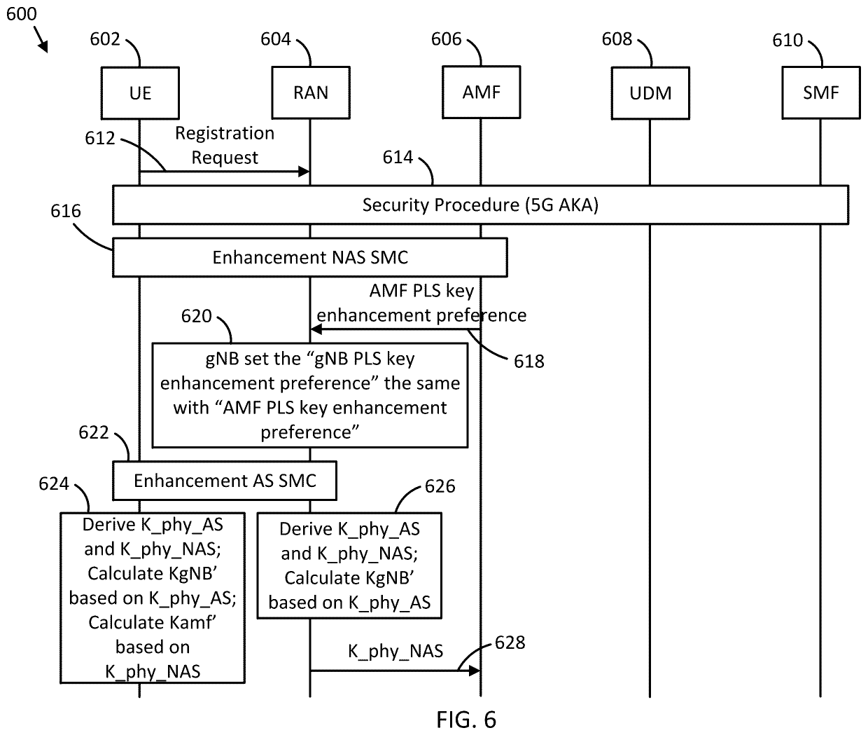

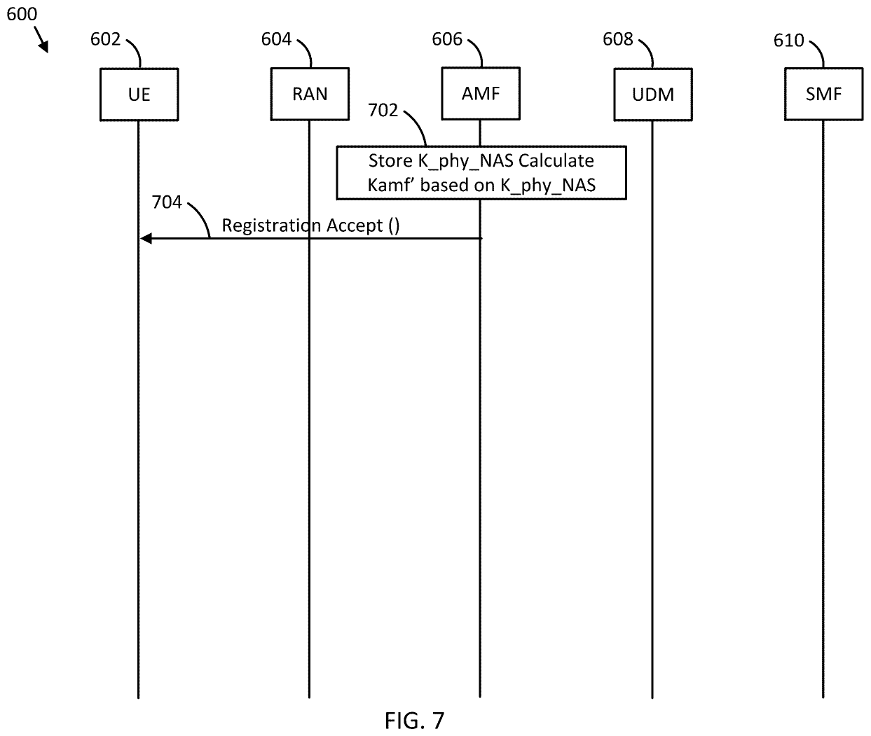

FIG. 6 illustrates a first portion of a NAS key derivation procedure 600 in accordance with some embodiments. FIG. 7 illustrates a second portion of the NAS key derivation procedure 600 in accordance with some embodiments. The procedure 600 may be performed to generate a NAS key in accordance with approaches described herein.

The procedure 600 includes a UE 602. The UE 602 may include one or more of the features of the UE 104 (FIG. 1), the UE 106 (FIG. 1), and/or the UE 200 (FIG. 2). The procedure 600 further includes a radio access network (RAN) node 604, such as base station.

The procedure 600 further includes one or more portions of a core network. The portions of the core network includes an AMF 606, a unified data management (UDM) 608, and a session management function 610 in the illustrated embodiment.

When a UE first connects to a base station, the UE may perform a registration procedure, and may derive a security anchor function key (Kseaf) after fifth generation (5G) authentication and key agreement (AKA). For example, the UE 602 may transmit a registration request 612 to the RAN node 604 to register with the RAN node 604.

In 614, the UE 602 may perform a security procedure. In the security procedure, a security anchor function (SEAF) may derive an AMF key (Kamf). The SEAF may send the Kamf to the AMF 606. The UE 602 may also derive the Kamf from the Kscaf. The AMF 606 may derive a base station key (kgNB) and may send the kgNB to the RAN node 604. The UE 602 may also derive K_{gNB} from Kamf. The registration request 612 and the security procedure in 614 may reuse legacy 5G key derivation design.

When AMF and UE perform NAS SMC, they negotiate on whether to use PLS-key enhancement and whether to separate physical keys for access stratum (AS) and NAS layer. For example, the AMF and UE may perform an enhancement NAS SMC operation in 616. The AMF and the UE may negotiate on whether to use PLS-key enhancement. In some embodiments, the AMF and UE may further negotiate whether to use one physical key or separate physical keys for an AS layer or an NAS layer.

If the result of negotiation in 616 is no, then the AMF and UE may follow the legacy 5G procedures on key derivation. If the result of negotiation in 616 is yes, then the AMF 606 may indicate to the RAN node 604 an “AMF PLS key enhancement preference” to enable the PLS-key enhancement in AS SMC along with how many PLS keys are to be derived. For example, the AMF 606 may transit an AMF PLS key enhancement preference 618 to the RAN node 604. The AMF PLS key enhancement preference 618 may include the indications of whether to enable the PLS-key enhancement and/or how may PLS key are to be derived.

The RAN node 604 may set the “gNB PLS key enhancement preference” same as “AMF PLS key enhancement preference” and start the enhanced AS SMC. For example, the RAN node 604 may set a base station PLS key enhancement preference to be the same as the AMF PLS key enhancement preference received in 618.

The RAN node 604 and the UE 602 may perform the PLS key generation. For example, the RAN node 604 and the UE 602 may perform an enhancement AS SMC operation in 622. The enhancement AS SMC operation may include generation of a PLS key.

The UE 602 may generate one or more keys in 624. For example, the UE 602 may derive a physical layer AS key (K_phy_AS) and/or a physical layer NAS key (K_phy_NAS) as an output of 624. Further, the UE 602 may generate an enhanced base station key (KgNB′) based on the K_phy_AS in 624. The UE 602 may apply the K_phy_NAS on the NAS layer key derivation, and may derive an enhanced AMF key (Kamf) based on K_phy_NAS.

The RAN node 604 may generate one or more keys in 626. For example, the RAN node 604 may derive the K_phy_AS and K_phy_NAS as the output of 626. In a first alternative, following the indication in NAS layer, the RAN node 604 and the UE 602 may derive two physical layer keys for AS and NAS separately, or gNB and UE may only derive one physical layer key (K_phy) for both AS and NAS layer. Further, the RAN node 604 may generate KgNB′ based on K_phy_AS.

The RAN node 604 may then send K_phy or K_phy_NAS to the AMF 606 to enhance the NAS layer key derivation. For example, the RAN node 604 may generate and/or transmit a transmission 628 with the K_phy or the K_phy_NAS.

The AMF 606 may apply the K_phy_NAS on the NAS layer key derivation, and may derive the Kamf based on the K_phy_NAS. For example, the AMF 606 may store the K_phy_NAS and calculate the Kamf′ based on the K_phy_NAS in 702.

The AMF 606 may generate and/or transmit a registration accept message 704 to the UE 602. The registration accept message 704 may indicate that the UE 602 has been registered with the AMF 606.

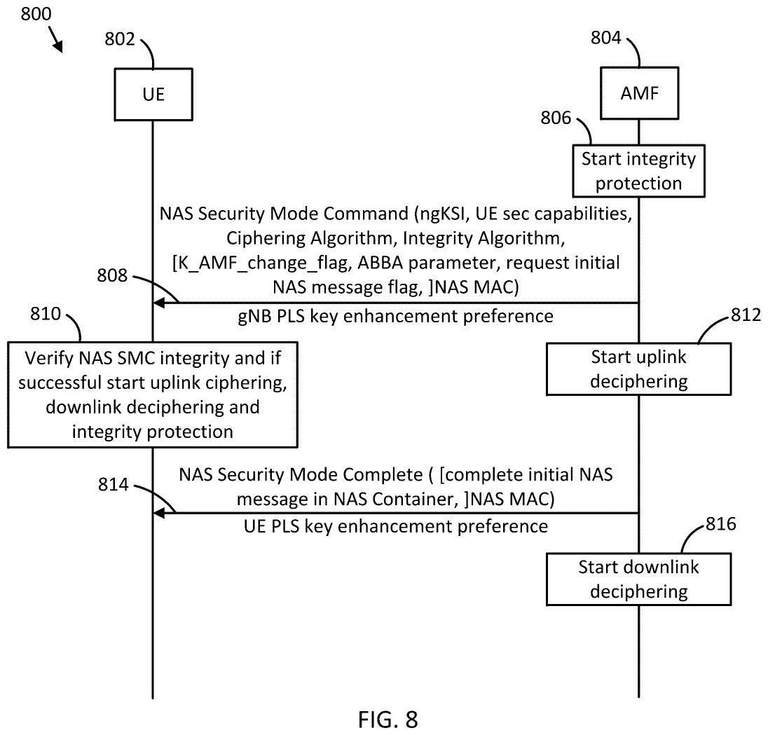

FIG. 8 illustrates an example NAS security mode command procedure 800 in accordance with some embodiments. The procedure 800 illustrates an example NAS SMC with added PLS key enhancement in accordance with approaches herein. The procedure 800 may be performed as part of 616 (FIG. 6).

The procedure 800 includes a UE 802. The UE 802 may include one or more of the features of the UE 104 (FIG. 1), the UE 106 (FIG. 1), and/or the UE 200 (FIG. 2). The procedure 800 further includes an AMF 804. The AMF 804 may be part of a core network to which the UE 802 is registering. The AMF 804 may communicate with the UE via a base station, such as the base station 108 (FIG. 1), and/or the network device 300 (FIG. 3).

The AMF 804 may activate the NAS integrity protection in 806 before sending a NAS Security Mode Command message.

The AMF 804 may send the NAS Security Mode Command message 808 to the UE 802. The NAS Security Mode Command message 808 may contain the replayed UE security capabilities, the selected NAS algorithms, and/or the ngKSI for identifying the K_{AMF}. The NAS Security Mode Command message 808 may contain K_AMF_change_flag (carried in an additional 5G security parameters information element (IE)) to indicate a new K_{AMF} is calculated, a flag requesting the complete initial NAS message (see subclause 6.4.6), an anti-bidding down between architectures (ABBA) parameter, and/or a PLS key enhancement preference. In the case of horizontal derivation of K_{AMF} during mobility registration update or during multiple registration in same PLMN, K_AMF_change_flag may be included in the NAS Security Mode Command message.

A “Network PLS key enhancement preference” IE may be included with the NAS security mode command message 808. The NAS PLS key enhancement preference IE may contain two bits representing whether to use PLS-key enhancement, whether to have separate physical keys for AS and NAS layer, and/or also other information.

The AMF 804 may activate the NAS uplink deciphering in 812 after sending the NAS Security Mode Command message 808.

The UE 802 may verify the NAS security mode command message 808 in 812. This may include checking that the UE security capabilities sent by the AMF 804 match the ones stored in the UE 802 to ensure that these were not modified by an attacker and verifying the integrity protection using the indicated NAS integrity algorithm and the NAS integrity key based on the KAME indicated by the ngKSI. If the verification of the integrity of the NAS security mode command message 808 is successful, the UE 802 may start NAS integrity protection and ciphering/deciphering with the security context indicated by the ngKSI.

The UE 802 may send the NAS security mode complete message 814 to the AMF 804. The NAS security mode complete message 814 may be ciphered and integrity protected. The UE 802 may include “UE PLS key enhancement preference” IE in the NAS security mode complete message 814. If UE 802 does not support PLS key enhancement, UE 802 may send “00” in the UE PLS key enhancement preference IE. If UE 802 supports PLS key enhancement, the UE 802 may follow the guidance in NAS security mode command message 808 sent by the AMF 804 via a base station. In a first alternative, the UE 802 can also send its preference on whether to use separate physical layer keys for AS and NAS. If the policy from the UE 802 and AMF 804 doesn't match, the base station associated with the AMF 804 may not enable the PLS key enhancement.

The procedure 800 may include the AMF 804 starting downlink deciphering in 816.

Approaches described herein may derive KgNB′ and Kamf′ in accordance with the following method. The methods for deriving KgNB′ based on K_phy_AS may include a first method and a second method. In a first method (which may be referred to as “Method 1”), KgNB′=K_{gNB} XOR K_phy_AS. For example, the KgNB′ may be equal to the exclusive or of K_{gNB} and K_phy_AS. In a second method (which may be referred to as “Method 2”), KgNB′=KDF (K_{gNB} XOR K_phy_AS). For example, the KgNB′ may be equal to the key derivation function (KDF) of the exclusive or of K_{gNB} and K_phy_AS.

The methods for deriving Kamf based on K_phy_NAS may include a third method and a fourth method. In a third method (which may be referred to as “Method 3”), Kamf=Kamf XOR K_phy_NAS. For example, Kamf′ may be equal to the exclusive or of Kamf and K_phy_NAS. In a fourth method (which may be referred to as “Method 4”), Kamf′=KDF (Kamf XOR K_phy_NAS). For example, the Kamf′ may be equal to the KDF of the exclusive or of Kamf and K_phy_NAS.

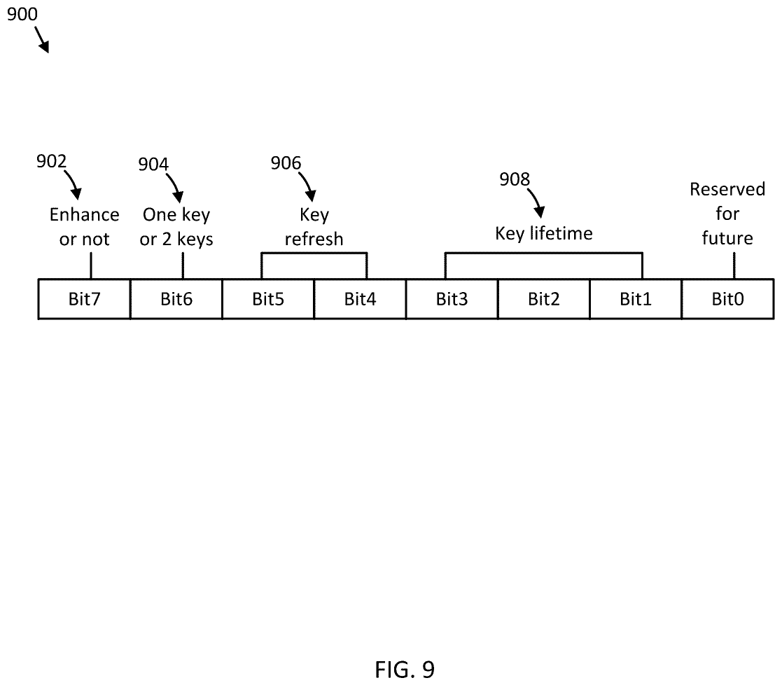

FIG. 9 illustrates an example PLS key enhancement preference IE 900 in accordance with some embodiments. The format of the IE 900 may be used for the network PLS key enhancement preference (such as the gNB PLS key enhancement preference and/or the NAS PLS key enhancement preference. FIG. 9 is one example of the format of this IE 900, assuming the length is 8 bits. It should be the IE 900 may include a different number of bits.

The PLS key enhancement preference IE 900 may contain the following information: whether to use PLS-key enhancement; whether to separate physical keys for AS and NAS layer; what is the key length; what is the key lifetime, i.e., when to refresh the key; and/or other information.

For example, example, the IE 900 may include a first bit 902 that indicates whether to use PLS-key enhancement. The value of the first bit 902 may indicate whether or not PLS-key enhancement is to be utilized.

The IE 900 may include a second bit 904 that indicates whether separate physical keys are to be used for AS and NAS layer. For example, one value of the second bit 904 may indicate that a same physical key is to be used for the AS layer and the NAS layer. Another value of the second bit 904 may indicate that separate physical keys are to be used for the AS layer and the NAS layer.

The IE 900 may include key refresh information 906. The key refresh information 906 may be indicated by one or more bits, such as the two bits illustrated. The key refresh information 906 may indicate when the PLS key is to be refreshed.

The IE 900 may include key lifetime information 908. The key lifetime information 908 may be indicated by one or more bits, such as the three bits illustrated. The key lifetime information 908 may indicate a key lifetime for the PLS key.

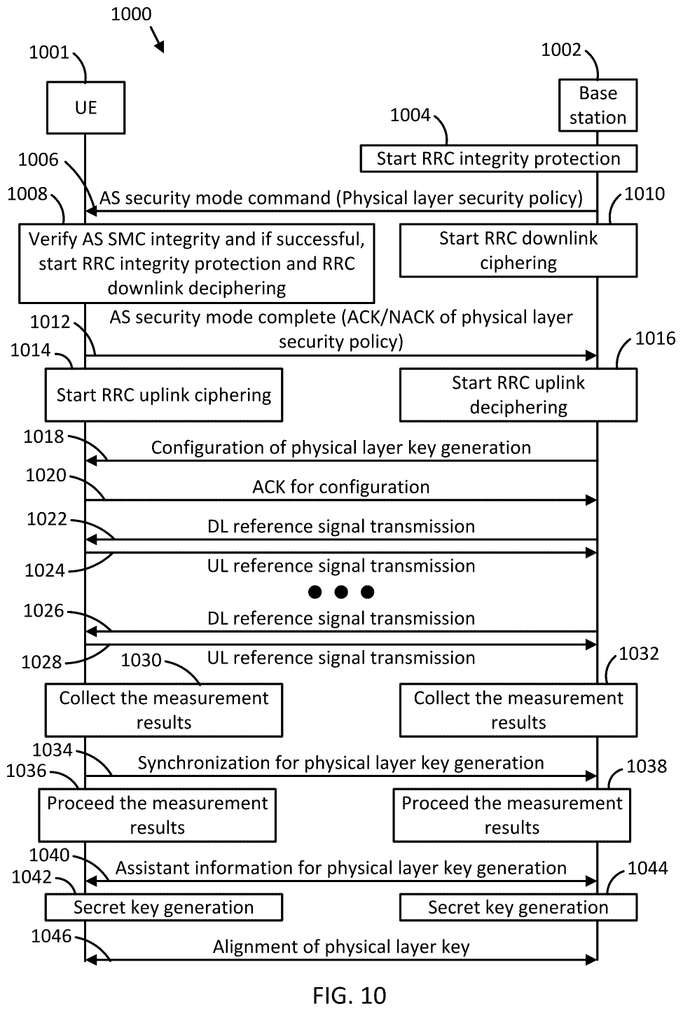

FIG. 10 illustrates an example procedure 1000 of generating physical layer secret keys in cellular system in accordance with some embodiments. For example, the procedure 1000 may include general procedures of generating physical layer secret keys in a cellular system.

The procedure 1000 includes a UE 1001. The UE 1001 may include one or more of the features of the UE 104 (FIG. 1), the UE 106 (FIG. 1), and/or the UE 200 (FIG. 2). The procedure 1000 further includes a base station 1002. The base station 1002 may include one or more of the features of the base station 108 (FIG. 1), and/or the network device 300 (FIG. 3).

If “AS security mode complete” contains “ACK/NCK of physical layer security policy,” then the UE 1001 and the base station 1002 may start to generate physical layer key. For example, the base station 1002 may start a radio resource control (RRC) integrity protection operation in 1004. The base station 1002 may generate and/or transmit an AS security mode command message 1006 to the UE 1001. The AS security mode command message 1006 may include a physical layer security policy.

In 1008, the UE 1001 may verify AS SMC integrity and, if successful, start RRC integrity protection and RRC downlink deciphering. In 1010, the base station 1002 may start RRC downlink ciphering.

The UE 1001 may generate and/or transmit an AS security mode complete message 1012 to the base station 1002. The AS security mode complete message 1012 may include an acknowledge (ACK) or a negative acknowledge (NACK) of the physical layer security policy.

In 1014, the UE 1001 may start RRC ciphering. In 1016, the base station 1002 may start RRC uplink deciphering.

The procedure 1000 may include the base station 1002 sending configuration of physical layer key generation message 1018 to the UE 1001. The contents of the configuration may include configuration of downlink reference signal, configuration of uplink reference signal, and/or configuration of physical layer key generation. A container of the configuration may be a dedicated RRC message.

The procedure 1000 may include the UE 1001 sending the ACK of the configuration message 1020 to the base station 1002. It is possible that the UE 1001 may send the modified configuration with base station 1002 (e.g., the periodicity of downlink (DL)/uplink (UL) reference signals).

The procedure 1000 may include one or more DL/UL reference signal transmissions. For example, the procedure 1000 includes a first DL reference signal transmission 1022, a first UL reference signal transmission 1024, a second DL reference signal transmission 1026, and a second UL reference signal transmission 1028 in the illustrated embodiments. The DL/UL reference signal transmissions may be paired transmissions, where one DL reference signal transmission has the corresponding UL reference signal transmission. It is possible that a DL reference signal is transmitted before or after a UL reference signal, depending on the configuration of DL/UL reference signal. It is possible DL/UL reference signals are periodic, with or without ON/OFF duration.

In 1030, the UE 1001 may collect measurement results. In 1032, the base station 1002 may collect measurement results.

The procedure 1000 may include synchronization for physical layer key generation. A synchronization for physical layer key generation message 1034 can be both from UE to base station and from base station to UE. For example, the synchronization for physical layer key generation message 1034 is transmitted from the UE 1001 to the base station 1002 in the illustrated embodiment. This message may be triggered when a certain number of DL/UL reference signal transmissions depending on configuration.

Contents of the synchronization for physical layer key generation message 1034 may include a bitmap of length being the number of DL (or UL) reference signal transmissions from the previous synchronization message or from the beginning of the DL reference signal transmissions. The bitmap may include a bit of ‘0’ that indicates the corresponding DL (or UL) reference signal measurement is successful or reliable, or a bit of ‘1’ that indicates the corresponding DL (or UL) reference signal measurement is unsuccessful or not reliable. In a first alternative, a container for the physical layer key generation message 1034 may include a medium access control (MAC) control element (CE). The length of the MAC CE may be limited. In a second alternative, a container for the physical layer key generation message 1034 may include a dedicated RRC message.

In 1036, the UE 1001 may proceed with the measurement results. In 1038, the base station 1002 may proceed with the measurement results.

The procedure 1000 may include assistant information for physical layer key generation. An assistant information for physical layer key generation message 1040 can be cither from UE 1001 to base station 1002 or from base station 1002 to UE 1001, depending on configuration. Contents of the assistant information for physical layer key generation message 1040 may include cyclic redundancy check (CRC) bits of polar codes or syndrome bits of low-density parity-check (LDPC) codes, and/or quantization error bits. A container for the assistant information for physical layer key generation message 1040 may MAC CE in a first alternative or a dedicated RRC message in a second alternative.

In 1042, the UE 1001 may proceed with secret key generation. In 1044, the base station 1002 may proceed with secret key generation.

The procedure 1000 may include alignment of physical layer key. An alignment of physical layer key message 1046 can be from the UE 1001 to the base station 1002 in some instances, and base station 1002 may send acknowledge (ACK) or negative acknowledge (NACK) for the alignment results. In other instances, it can be from the base station 1002 to UE 1001, and the UE 1001 may send ACK or NACK for the alignment results. The contents of the alignment of physical layer key message 1046 may include a bit sequence which is derived from the physical layer key. The container of the alignment of physical layer key message 1046 may be a MAC CE in a first alternative or a dedicated RRC message in a second alternative.

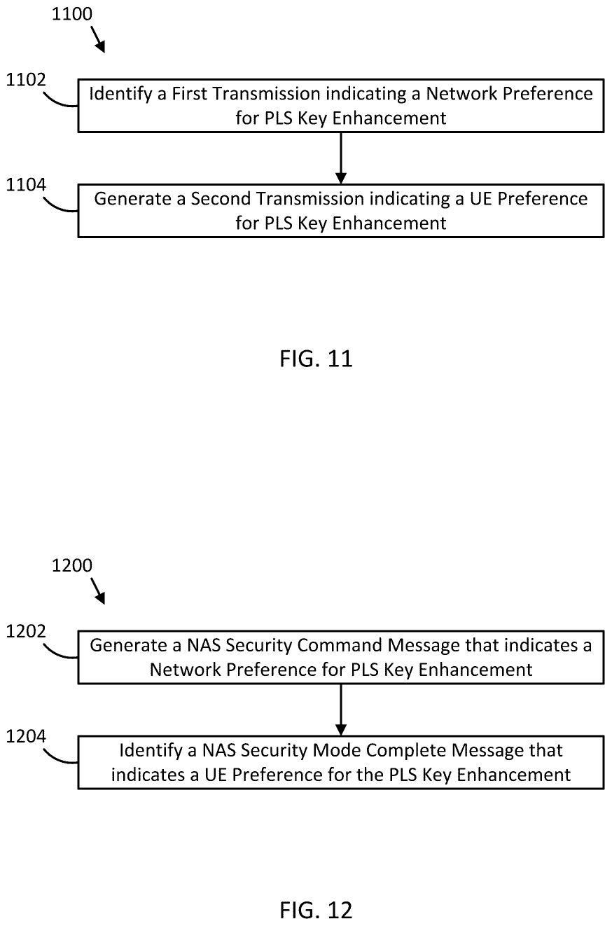

FIG. 11 illustrates an example procedure 1100 for PLS key enhancement in accordance with some embodiments. For example, the procedure 1100 may include configuring devices of a network for a PLS key enhancement generation. The procedure 1100 may be performed by a UE, such as the UE 104 (FIG. 1), the UE 106 (FIG. 1), and/or the UE 200 (FIG. 2).

The procedure 1100 may include identifying a first transmission indicating a network preference for PLS key enhancement in 1102. The first transmission may be received from an AMF.

In some embodiments, the first transmission may include a network PLS key enhancement preference information element that indicates the network preference for the PLS key enhancement. In some of these embodiments, the network PLS key enhancement preference information element may further indicate key refresh information and key lifetime information.

The procedure 1100 may include generating, for transmission to the AMF, a second transmission indicating a UE preference for the PLS key enhancement in 1104.

In some embodiments, the first transmission may include a NAS security mode command message. The second transmission may include a NAS security mode complete message.

In some embodiments, the second transmission may include a UE PLS key enhancement preference information element that indicates the UE preference for the PLS key enhancement.

In some embodiments, the first transmission may further indicate a network preference for whether to have separate physical keys for access stratum (AS) layer and non-access stratum (NAS) layer. In some of these embodiments, the second transmission may further indicate a UE preference for whether to have separate physical keys for AS layer and NAS layer.

In some embodiments, the procedure 1100 may further include determining that the PLS key enhancement is to be implemented. Further, the procedure 1100 may include generating an enhanced base station key based at least in part on a physical layer access stratum (AS) key, the enhanced base station key derived based at least in part on the determination that the PLS key enhancement is to be implemented.

In some embodiments, the procedure 1100 may further include determining that the PLS key enhancement is to be implemented. Further, the procedure 1100 may include generating an enhanced access and mobility management function (AMF) key based at least in part on the determination that the PLS key enhancement is to be implemented.

Any one or more of the operations in FIG. 11 may be performed in a different order than shown and/or one or more of the operations may be performed concurrently in embodiments. Further, it should be understood that one or more of the operations may be omitted from and/or one or more additional operations may be added to the procedure 1100 in other embodiments.

FIG. 12 illustrates an example procedure 1200 for PLS key enhancement in accordance with some embodiments. For example, the procedure 1200 may include configuring devices of a network for a PLS key enhancement generation. The procedure 1200 may be performed by a base station, such as the base station 108 (FIG. 1), and/or the network device 300 (FIG. 3).

The procedure 1200 may include generating, for transmission to a user equipment, an access stratum (AS) security mode command message that indicates a network preference for physical layer security (PLS) key enhancement in 1202.

In some embodiments, the AS security mode command message may include a network PLS key enhancement preference information element that indicates the network preference for the PLS key enhancement. In some of these embodiments, the network PLS key enhancement preference information element may further indicate a network preference for whether separate physical keys are to be used for an access stratum (AS) layer and an NAS layer. In some of these embodiments, the network PLS key enhancement preference information element may further indicate key refresh information and key lifetime information for one or more keys related to the PLS key enhancement.

The procedure 1200 may include identifying a NAS security mode complete message that indicates a user equipment (UE) preference for the PLS key enhancement in 1204.

In some embodiments, the procedure 1200 may further include generating a message, for transmission to an access and mobility management function (AMF), that includes the UE preference for the PLS key enhancement. Further, the procedure 1200 may include identifying an AMF preference for the PLS key enhancement, the AMF preference for the PLS key enhancement received from the AMF. In some of these embodiments, the procedure 1200 may further include determining that the AMF preference for the PLS key enhancement indicates that the PLS key enhancement is to be implemented, and generating an enhanced base station key based at least in part on a physical layer access stratum (AS) key.

Any one or more of the operations in FIG. 12 may be performed in a different order than shown and/or one or more of the operations may be performed concurrently in embodiments. Further, it should be understood that one or more of the operations may be omitted from and/or one or more additional operations may be added to the procedure 1200 in other embodiments.

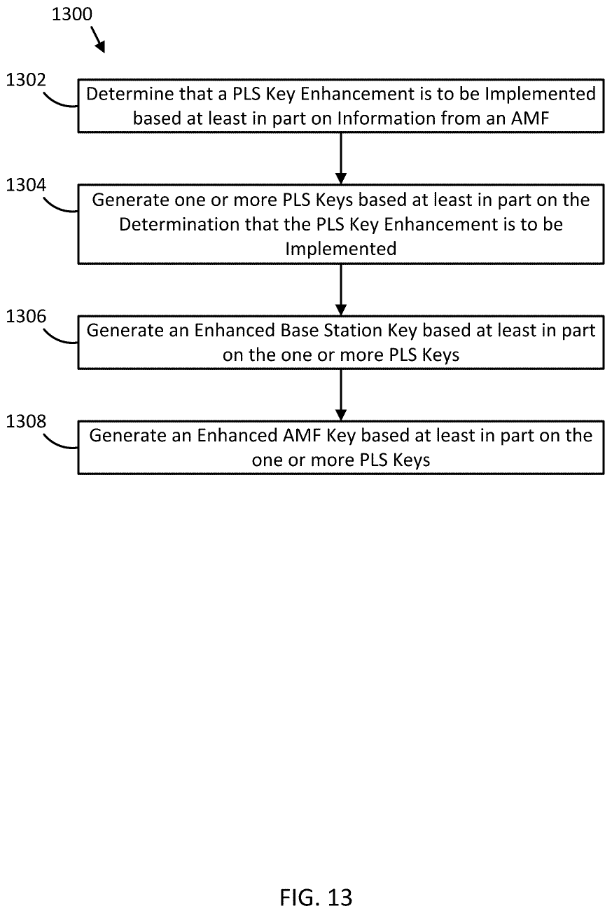

FIG. 13 illustrates an example procedure 1300 for key generation in accordance with some embodiments. For example, the procedure 1300 may include generating keys for a PLS key enhancement. The procedure 1300 may be performed by a UE, such as the UE 104 (FIG. 1), the UE 106 (FIG. 1), and/or the UE 200 (FIG. 2).

The procedure 1300 may include determining that a physical layer security (PLS) key enhancement is to be implemented based at least in part on information from an access and mobility management function (AMF) in 1302.

The procedure 1300 may include generating one or more PLS keys based at least in part on the determination that the PLS key enhancement is to be implemented in 1304.

The procedure 1300 may include generating an enhanced base station key based at least in part on the one or more PLS keys in 1306.

The procedure 1300 may include generating an enhanced AMF key based at least in part on the one or more PLS keys.

In some embodiments, generating the one or more PLS keys may include generating a single PLS key for an access stratum (AS) layer and a non-access stratum (NAS) layer. The enhanced base station key may be generated based at least in part on the single PLS key. The enhanced AMF key may be generated based at least in part on the single PLS key.

In some embodiments, generating the one or more PLS keys may include generating a first PLS key for an access stratum (AS) layer and a second PLS key for a non-access stratum (NAS) layer. The enhanced base station key may be generated based at least in part on the first PLS key. The enhanced AMF key may be generated based at least in part on the second PLS key.

The procedure 1300 may further include identifying a received network PLS key enhancement preference information element in some embodiments. The received network PLS key enhancement preference information element may include the information for determining that the PLS key enhancement is to implemented. In some of these embodiments, the received network PLS key enhancement preference information element may include a first field that indicates a network preference for the PLS key enhancement and a second field that indicates a network preference for a number of the one or more PLS keys.

Any one or more of the operations in FIG. 13 may be performed in a different order than shown and/or one or more of the operations may be performed concurrently in embodiments. Further, it should be understood that one or more of the operations may be omitted from and/or one or more additional operations may be added to the procedure 1300 in other embodiments.

SUCI enhancement with PHY security. SUCI requirements in TS 33.501. If the operator's decision, indicated by the USIM, is that the USIM shall calculate the SUCI, then the USIM shall not give the ME any parameter for the calculation of the SUCI including the Home Network Public Key Identifier, the Home Network Public Key, and the Protection Scheme Identifier. If the ME determines that the calculation of the SUCI, indicated by the USIM, shall be performed by the USIM, the ME shall delete any previously received or locally cached parameters for the calculation of the SUCI including the SUPI Type, the Routing Indicator, the Home Network Public Key Identifier, the Home Network Public Key and the Protection Scheme Identifier. The operator should use proprietary identifier for protection schemes if the operator chooses that the calculation of the SUCI shall be done in USIM.

If the operator's decision is that ME shall calculate the SUCI, the home network operator shall provision in the USIM an ordered priority list of the protection scheme identifiers that the operator allows. The priority list of protection scheme identifiers in the USIM shall only contain protection scheme identifiers specified in Annex C, and the list may contain one or more protection schemes identifiers. The ME shall read the SUCI calculation information from the USIM, including the SUPI, the SUPI Type, the Routing Indicator, the Home Network Public Key Identifier, the Home Network Public Key and the list of protection scheme identifiers. The ME shall select the protection scheme from its supported schemes that has the highest priority in the list are obtained from the USIM. The ME shall calculate the SUCI using the null-scheme if the Home Network Public Key or the priority list are not provisioned in the USIM.

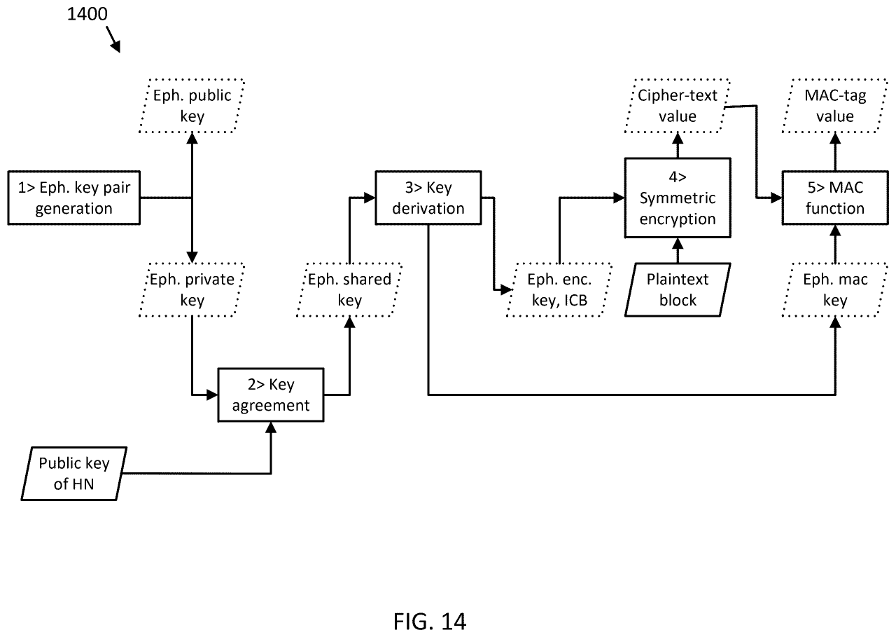

FIG. 14 illustrates an example procedure 1400 for encryption based on elliptic curve integrated encryption scheme (ECIES) at a UE in accordance with some embodiments. In particular, the procedure 1400 illustrates UE side processing for an ECIES encryption process.

The procedure 1400 may include generating keying data K of length enckeylen+icblen+mackeylen. Further, the procedure 1400 may include parsing the leftmost enckeylen octets of K as an encryption key EK, the middle icblen octets of K as an indexed code book (ICB), and the rightmost mackeylen octets of K as a MAC key MK. The final output may be the concatenation of the ECC ephemeral public key, the ciphertext value, the MAC tag value, and any other parameters, if applicable. For example, the final output may be equal to the ephemeral public key∥Ciphertext∥MAC tag[∥any other parameter].

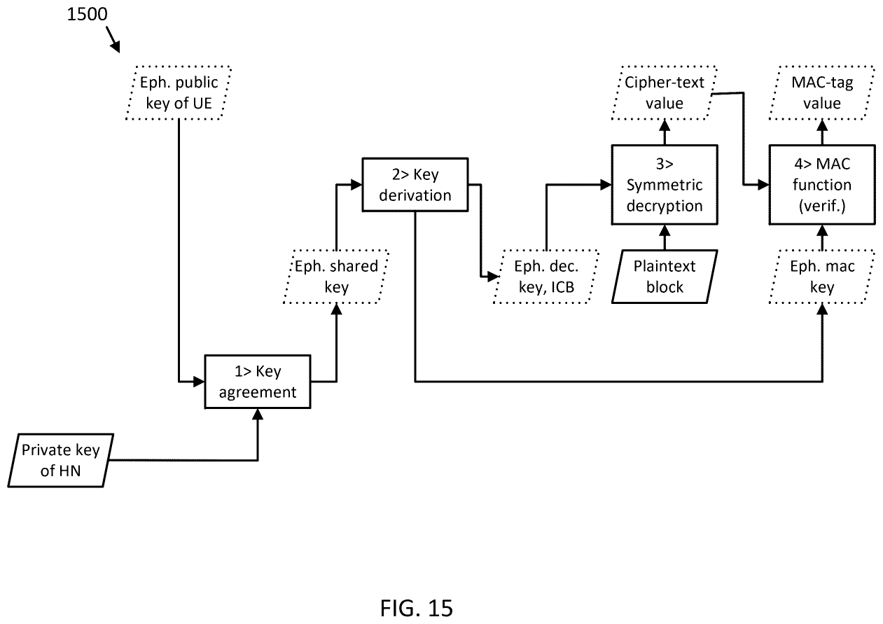

FIG. 15 illustrates an example procedure 1500 for decryption based on ECIES at a home network in accordance with some embodiments. In particular, the procedure 1500 illustrates home network side processing for an ECIES decryption process.

The procedure 1500 may include generating keying data K of length enckeylen+ichlen+mackeylen. Further, the procedure 1500 may include parsing the leftmost enckeylen octets of K as an encryption key EK, the middle icblen octets of K as an ICB, and the rightmost mackeylen octets of K as a MAC key MK. Unlike the UE, the home network does not need to perform a fresh ephemeral key pair generation for each decryption. How often the home network generates new public/private key pair and how the public key is provisioned to the UE are out of the scope of this clause.

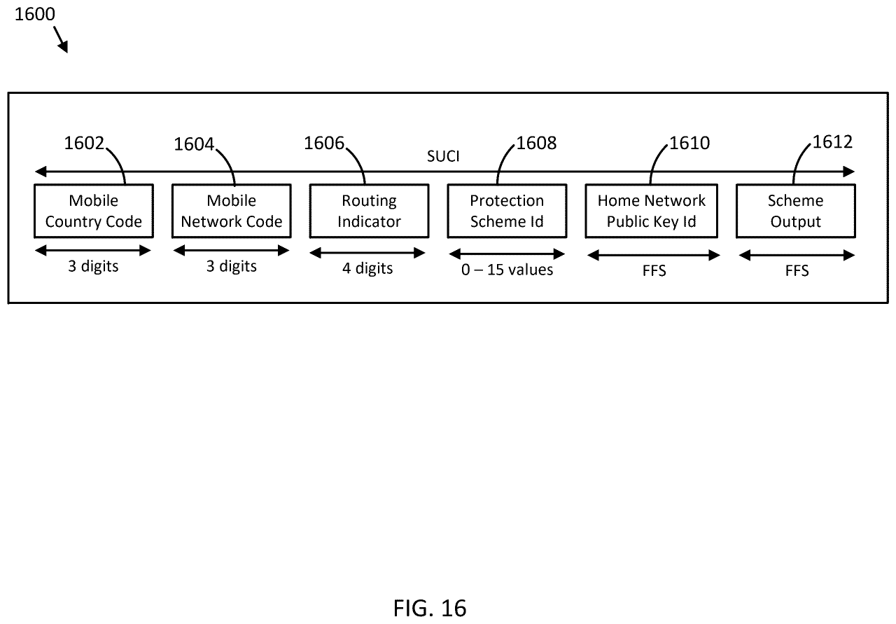

FIG. 16 illustrates an example subscription concealed identifier (SUCI) arrangement 1600 in accordance with some embodiments. The SUCI represented in the SUCI arrangement 1600 may be utilized for third generation partnership project (3GPP) technical specification (TS) 33.501 (3rd Generation Partnership Project; Technical Specification Group Services and System Aspects; Security architecture and procedures for 5G system (Release 19). (2025). 3GPP TS 33.501, 19.1.0) and/or 3GPP TS 23.003 (3rd Generation Partnership Project; Technical Specification Group Core Network and Terminals; Numbering, addressing and identification; (Release 19). (2024). 3GPP TS 23.003, 19.1.0).

The UE may construct a scheme-input from the subscription identifier part of the SUPI as follows. For SUPIs containing international mobile subscriber identity (IMSI), the subscription identifier part of the SUPI may include the mobile subscriber identification number (MSIN) of the IMSI as defined in 3GPP TS 23.003. For SUPIs taking the form of a network access identifier (NAI), the subscription identifier part of the SUPI may include the “username” portion of the NAI.

The SUCI arrangement 1600 may include a home network identifier. The home network identifier may include two parts: a mobile country code (MCC) 1602 and a mobile network code (MNC) 1604. The MCC 1602 may consist of three decimal digits. Further, the MCC 1602 may identify uniquely the country of domicile of the mobile subscription. The MNC 1604 may consist of three decimal digits. Further, the MNC 1604 may contain two or three digits for 3GPP network applications. The MNC 1604 may identify the home public land mobile network (PLMN) of the mobile subscription. The length of the MNC 1604 (two or three digits) may depend on the value of the MCC. A mixture of two and three digit MNC codes within a single MCC area is not recommended. If there are only 2 significant digits in the MNC, one “0” digit may be inserted at the left side to fill the 3 digits coding of MNC.

The SUCI arrangement 1600 may include a routing indicator 1606. The routing indicator 1606 may consist of four decimal digits. The routing indicator 1606 may contain 1 to 4 digits assigned by the home network operator and provisioned in the USIM, that allow together with the MCC and MNC to route network signalling with SUCI to authentication server function (AUSF) and unified data management (UDM) instances capable to serve the subscriber. If there are less than 4 digits in the routing indicator 1606, one or more “0” digits may be inserted at the left side to fill the 4 digits coding of routing indicator 1606.

The SUCI arrangement 1600 may include a protection scheme identifier 1608. The protection scheme identifier 1608 may consist in a value in the range of 0 to 15. The protection scheme identifier 1608 may represent the null-scheme or a non-null-scheme specified in Annex C of 3GPP TS 33.501 or a protection scheme specified by the home public land mobile network (HPLMN).

The SUCI arrangement 1600 may include a home network public key identifier 1610. The values and/or digits of the home network public key identifier 1610 may be for further study. The home network public key identifier 1610 may represent a public key provisioned by the HPLMN. In case of null-scheme being used, this data field may be set to null.

The SUCI arrangement 1600 may include a scheme output 1612. The values and/or digits of the scheme output 1612 may be for further study. The scheme output 1612 may represent the output of a public key protection scheme specified in Annex C of 3GPP TS 33.501 or a protection scheme specified by the HPLMN. For the execution of the command, the described information in the SUCI arrangement 1600 may be available in the universal subscriber identity module (USIM).

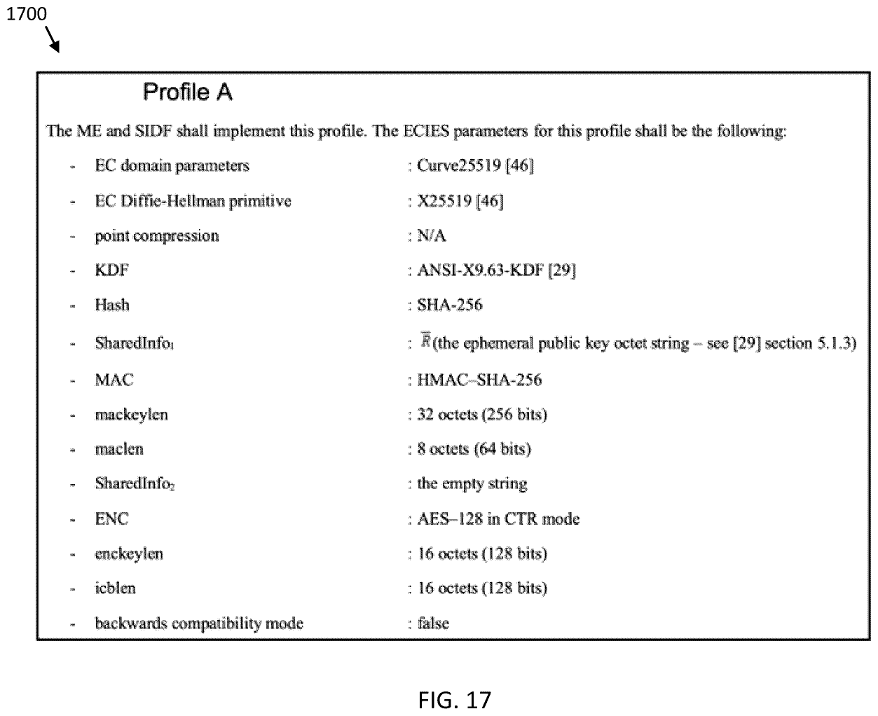

FIG. 17 illustrates an example SUCI profile A representation 1700 in accordance with some embodiments. The SUCI profile A representation 1700 may be included in TS 33.501. The SUCI profile A representation 1700 illustrates parameters for a SUCI implementing SUCI profile A.

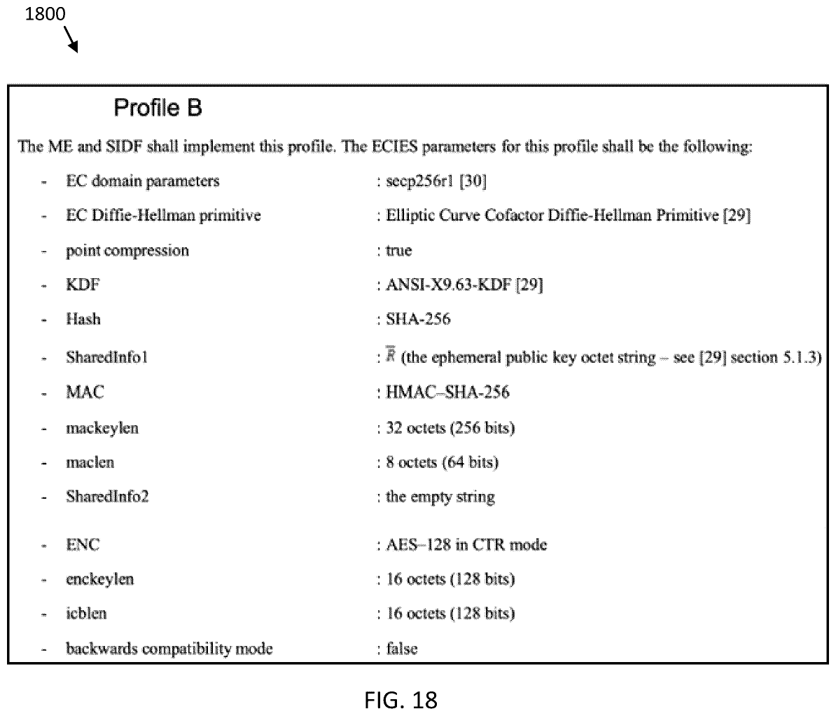

FIG. 18 illustrates an example SUCI profile B representation 1800 in accordance with some embodiments. The SUCI profile B representation 1800 may be included in TS 33.501. The SUCI profile B representation 1800 illustrates parameters for a SUCI implementing SUCI profile B.

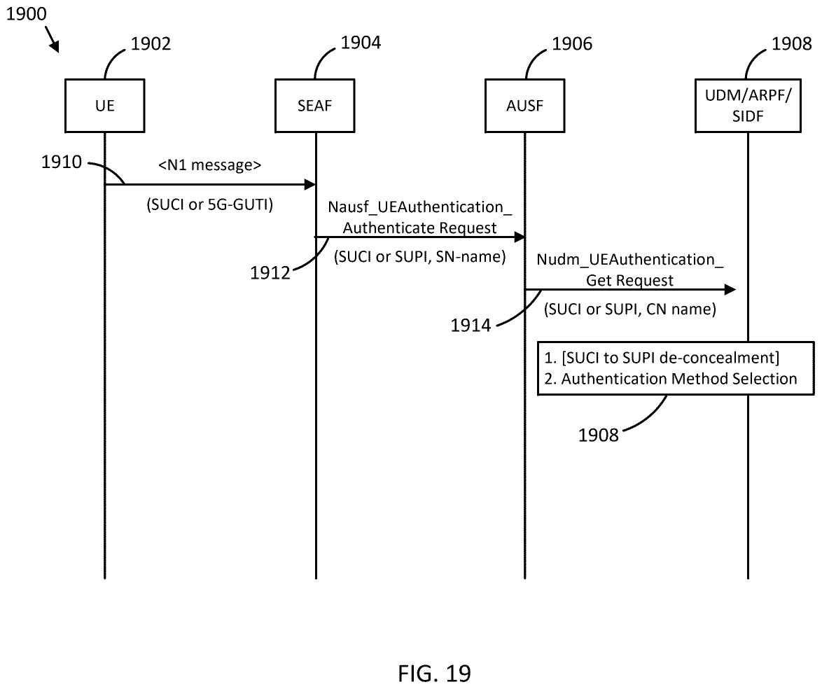

Existing procedure on authentication Phase 1 in TS 33.501. FIG. 19 illustrates an example procedure 1900 for initiation of authentication procedure and selection of authentication method in accordance with some embodiments. The procedure 1900 may be included in TS 33.501 and may be a procedure on authentication phase 1.

A security anchor function (SEAF) 1904 may initiate an authentication with a UE 1902 during any procedure establishing a signalling connection with the UE 1902, according to the SEAF's policy. The SEAF 1904 initiating the authentication with the UE 1902 may start the procedure 1900.

In 1910, the UE 1902 may use SUCI or fifth generation (5G)-globally unique temporary identifier (GUTI) in the Registration Request. For example, the UE 1902 may generate a registration request (which may be an NI message) for transmission to the SEAF 1904, where the registration request includes the SUCI or the 5G-GUTI.

In 1912, the SEAF 1904 may invoke the Nausf_UEAuthentication service by sending a Nausf_UEAuthentication_Authenticate Request message to a AUSF 1906 whenever the SEAF 1904 wishes to initiate an authentication. The Nausf_UEAuthentication_Authenticate Request message may contain either a SUCI (as defined in the accordance with a legacy definition), or a subscription permanent identifier SUPI (as defined in TS 23.501). The SEAF 1904 may include the SUPI in the Nausf_UEAuthentication_Authenticate Request message in case the SEAF 1904 has a valid 5G-GUTI and re-authenticates the UE 1902. Otherwise, the SUCI may be included in Nausf_UEAuthentication_Authenticate Request. The SUPI/SUCI structure is part of stage 3 protocol design.

In 1914, the Nudm_UEAuthentication_Get Request may be sent from the AUSF 1906 to a UDM 1908. The Nudm_UEAuthentication_Get Request may include the SUCI or SUPI, the serving network name, and/or, if received from SEAF, a disaster roaming service indication.

In 1908, upon reception of the Nudm_UEAuthentication_Get Request, the UDM 1908 may invoke a subscription identifier de-concealing function (SIDF) if a SUCI is received. The SIDF may de-conceal SUCI to gain SUPI before the UDM 1908 can process the request. Based on SUPI, the UDM 1908 and/or an authentication credential repository and processing function (ARPF) may choose the authentication method.

The SUCI mechanism is based on asymmetric crypto, which is threatened by quantum computing. If the attacker catches the SUCI in the air, they may compromise the system using the assistance of quantum computing. Perfect forward secrecy (PFS) is one way out for this vulnerability. In PFC, a UE and a base station may not only rely on the asymmetric key but also may rely on the symmetric keys derived from physical layer channel information. The input of the SUCI calculation may be configured into the USIM. Further, physical layer keys may be derived by mobile equipment (ME). When the USIM is compromised, the attacker needs to compromise the ME to compromise the SUCI_Enh.

A challenge presented is that the UE and the AUSF may need to negotiate on whether the SUCI or SUCI_Enh is supported by the UE and the HPLMN. The SUCI may be calculated in USIM or in ME. Approaches described herein may be applied to the case when the SUCI is calculated in the ME.

The approach on NAS layer physical layer key enhancement may be reused. For example, the NAS physical layer key enhancement as described throughout this disclosure may be utilized with the approaches of indicating SUCI enhancement support and/or deriving the SUCI enhancement as described further throughout this disclosure. The UE and the AUSF may leverage the physical layer key derived in the non-access stratum (NAS layer). It may be assumed that the UE and the AMF support the security capability.

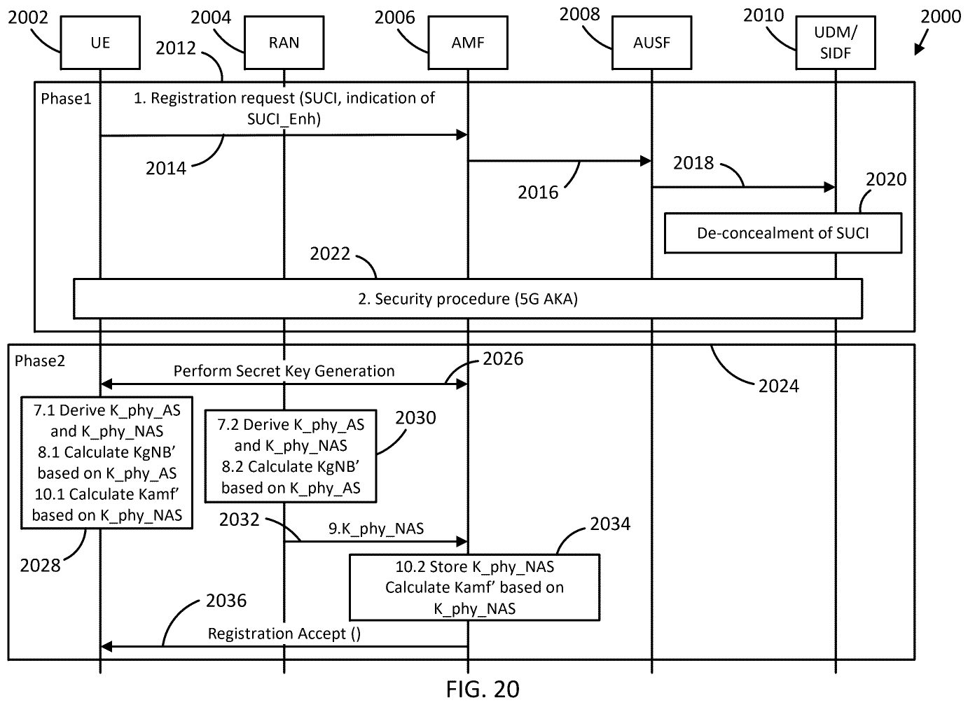

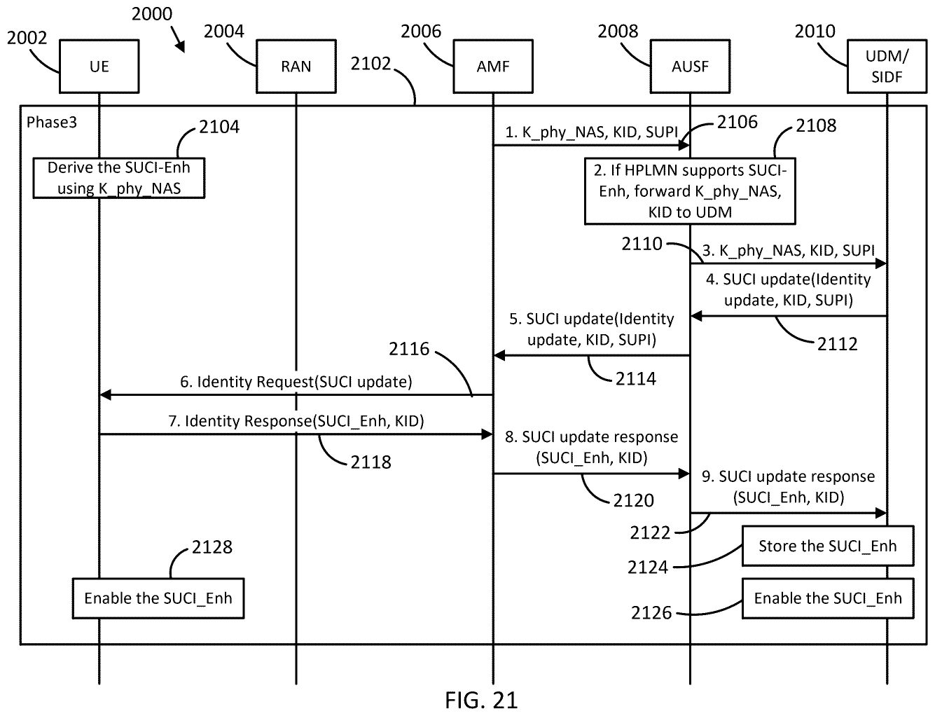

FIG. 20 illustrates a first portion of an example procedure representation 2000 for an approach related to SUCI enhancement in accordance with some embodiments. FIG. 21 illustrates a second portion of the example procedure representation 2000 for the approach related to SUCI enhancement in accordance with some embodiments.

The procedure representation 2000 includes a UE 2002. The UE 2002 may include one or more of the features of the UE 104 (FIG. 1), the UE 106 (FIG. 1), and/or the UE 200 (FIG. 2).

The procedure representation 2000 includes a RAN element 2004. The RAN element 2004 may be a base station. The RAN element 2004 may include one or more of the features of the base station 108 (FIG. 1) and/or the network device 300 (FIG. 3). In the illustrated embodiment, the UE 2002 may be establishing a connection with a wireless network via the RAN element 2004.

The procedure representation 2000 includes an AMF 2006. The AMF 2006 may be part of a core network of the wireless network to which the UE 2002 is establishing a connection. The AMF 2006 may be a control plane function in the core network that handles connection and management mobility tasks.

The procedure representation 2000 includes an AUSF 2008. The AUSF 2008 may be part of the core network of the wireless network. The AUSF 2008 may support authentication for access to the wireless network. Further, the AUSF 2008 may handle routing based on SUCI and/or SUPI.

The procedure representation 2000 includes a UDM/SIDF 2010. The UDM/SIDF 2010 may be part of the core network of the wireless network. The UDM/SIDF 2010 is a function that may manage data for the wireless network, such as user data. Further, the UDM/SIDF 2010 may be responsible for de-concealment of the SUCI.

The procedure representation 2000 may initiate a procedure with a first phase 2012 (which may be referred to as Phase 1). In the first phase 2012, the UE 2002 may perform a registration procedure in 2014. In some embodiments, the registration procedure may be the legacy registration procedure. The UE 2002 may generate and transmit a registration request for transmission to the AMF 2006. The registration request may include a SUCI, where the SUCI may be the same as legacy approaches. The UE may also indicate the capability of SUCI enhancement in the registration request message. For example, the registration request may include a SUCI enhancement indication to indicate to the AMF 2006 the capability of the UE 2002 of supporting SUCI enhancement. The AMF 2006 may forward the registration request to the AUSF 2008 in 2016. Further, the AUSF 2008 may forward the registration request to the UDM/SIDF 2010 in 2018.

In 2020, the UDM/SIDF 2010 may perform de-concealment of the SUCI received in the registration request. The system (including the UE 2002, the RAN element 2004, the AMF 2006, the AUSF 2008, and/or the UDM/SIDF 2010) may perform a security procedure in 2022. The security procedure performed may be the same as a legacy security procedure performed based on a registration request sent from a UE to an AMF. In some embodiments, the security procedure may include a fifth generation (5G) authentication and key agreement (AKA) procedure for authentication of the UE 2002 for registration.

The procedure representation 2000 may continue the procedure with a second phase 2024 (which may be referred to as Phase 2). Assuming the UE 2002 supports the physical layer key generation capability, the UE 2002 and the AMF 2006 may perform the approach of generating secret keys in the second phase 2024. For example, the UE 2002 and the AMF 2006 may perform secret key generation in 2026, in accordance with generating secret keys as described throughout this disclosure. The UE 2002 may derive K_phy_AS and K_phy_NAS keys in 2028. Further, the UE may store the K_phy_AS and the K_phy_NAS. Further, the RAN element 2004 may derive the K_phy_AS and the K_phy_NAS keys in 2030. The UE 2002 may calculate the KgNB′ based on the K_phy_AS in 2028. Further, the RAN element 2004 may calculate the KgNB′ based on the K_phy_AS in 2030. The RAN element 2004 may transmit the K_phy_NAS to the AMF 2006 in 2032. The UE 2002 may calculate Kamf based on the K_phy_NAS in 2028. The AMF 2006 may store the K_phy_NAS and calculate Kamf based on K_phy_NAS in 2034. If the AMF 2006 determines to accept registration of the UE 2002, the AMF 2006 may generate and transmit a registration accept message to the UE 2002 in 2036. Phase 1 and Phase 2 may be similar to legacy procedures, with exceptions of the capability of SUCI enhancement indication and the SUCI enhancement.

The procedure representation 2000 may continue the procedure with a third phase 2102. In the third phase 2102, the UE 2002 may derive the enhanced SUCI (SUCI-Enh) in 2104. If the AMF 2006 sends the K_phy_NAS and corresponding key identifier (KID) to the AUSF 2008, the AMF 2006 may also send the SUPI to the AUSF 2008 in 2106. For example, the AMF 2006 may generate a message that includes the K_phy_NAS, KID, and SUPI for transmission to the AUSF 2008.

The AUSF 2008 may check whether the HPLMN has supported the physical layer SUCI enhancement in 2108. If AUSF 2008 determines that the HPLMN has supported the physical layer SUCI enhancement, the procedure may proceed with 2110. If the AUSF 2008 determines that the HPLMN has not supported the physical layer SUCI enhancement, the AUSF 2008 may drop the message. In 2110, the AUSF 2008 forwards the (K_phy_NAS, KID, SUPI) to the UDM/SIDF 2010. This may be an implicit capability negotiation on HPLMN capability on SUCI enhancement. In 2110, the UDM/SIDF 2010 may store this K_phy_NAS, KID, together with the credentials for the same SUPI.

The UDM/SIDF 2010 may trigger the SUCI update procedure in 2112. Further, the UDM/SIDF 2010 may generate and send the SUCI update message to the AUSF 2008. The SUCI update message may include an identity update, the KID, and/or the SUPI. In 2114, the AUSF 2008 may send the SUCI update to AMF 2006, including the KID and SUPI, as well as the cause value “identity update.”

In 2116, the AMF 2006 may send an identity request to the UE 2002. For example, the AMF 2006 may generate and transmit an identity request to the UE 2002. The legacy identity request can be reused in 2116. The cause value “SUCI update” may be included in the identity request to indicate this is for an SUCI update.

In 2118, the UE 2002 may reply with SUCI_Enh in the identity response. For example, the UE 2002 may generate and transmit an identity response for transmission to the AMF 2006, where the identity response may include the SUCI_Enh and/or the KID. The UE 2002 may enable the SUCI_Enh after the identity response message.

In 2120, the AMF 2006 may forward the SUCI_Enh and KID to the AUSF 2008. For example, the AMF 2006 may generate and transmit a SUCI update response message to the AUSF 2008, where the SUCI update response message includes the SUCI_Enh and/or the KID. In 2122, the AUSF 2008 may forward the SUCI_Enh and KID to the UDM/SIDF 2010. For example, the AUSF 2008 may forward the SUCI update response message to the UDM/SIDF 2010.

In 2124, the UDM/SIDF 2010 may verify the SUCI_Enh based on the KID. The UDM/SIDF 2010 may further store the SUCI_Enh in 2124. If the SUCI_Enh is not correct, the UDM/SIDF 2010 may send a notification back to the AUSF 2008. The UDM/SIDF 2010 may enable the SUCI_Enh after the message. For example, the UDM/SIDF 2010 may enable the SUCI_Enh after receiving the SUCI update response. The UDM/SIDF 2010 may enable the SUCI_Enh in 2126. Further, the UE 2002 may enable the SUCI_Enh in 2128.

There may be two methods on deriving SUCI_Enh based on K_phy_NAS and SUCI. In a first method, SUCI_Enh=SUCI XOR K_phy_AS. For example, the SUCI_Enh may be derived based on a result of an exclusive-or operation of the SUCI and K_phy_AS. In a second method, SUCI_Enh=KDF (SUCI XOR K_phy_NAS). For example, the SUCI_Enh may be derived based on a result of a key derivation function (KDF) being applied to a result of an exclusive-or operation of the SUCI and K_phy_NAS). The KDF may be as specified in Annex B.2.0 of TS 33.220 (technical specification (TS) 33.220 (3rd Generation Partnership Project; Technical Specification Group Services and System Aspects; Generic Authentication Architecture (GAA); Generic Bootstrapping Architecture (GBA) (Release 18). (2024). 3GPP TS 33.220, 18.3.0).

There may be three methods on deriving KID based on K_phy_NAS. In a first method, KID=SHA256 (K_phy_NAS), truncated to 16 bits. For example, KID may be derived based on applying a SHA256 hash to K_phy_NAS and truncating the result to 16 bits. In a second method, KID=K_phy_NAS XOR SUPI, truncated to 16 bits. For example, KID may be derived based performing an exclusive-or operation with K_phy_NAS and SUPI, and truncating the result to 16 bits. In a third method, KID=KDF_{K_phy_NAS} (SUPI), truncated to 16 bits. For example, KID may be derived based on taking a result of a KDF being applied to the SUPI and truncating the result to 16 bits. The KDF may be as specified in Annex B.2.0 of TS 33.220.

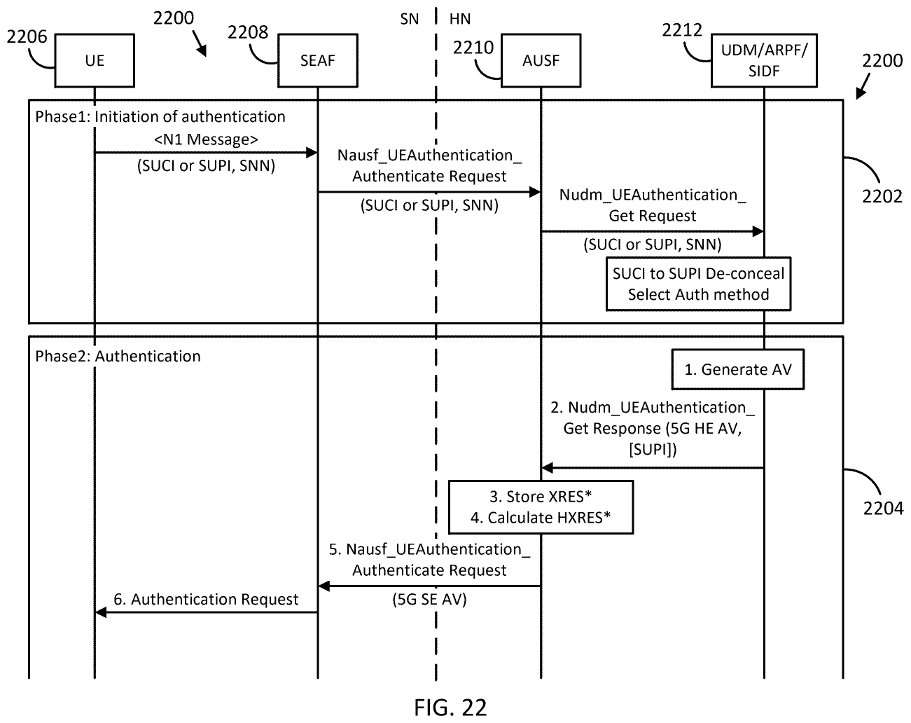

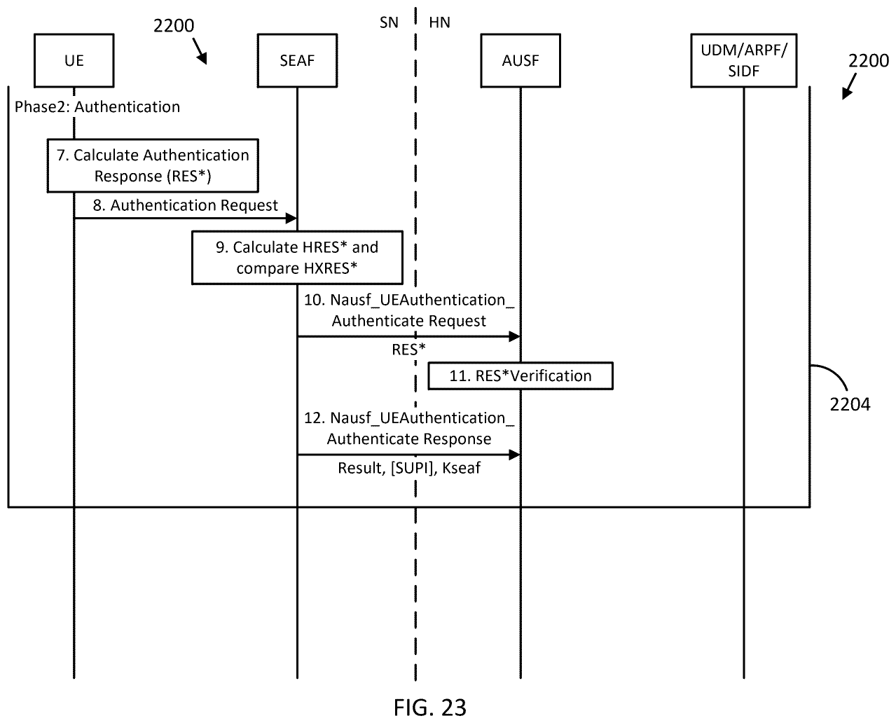

FIG. 22 illustrates a first portion of an example primary authentication procedure representation 2200 for 5G authentication and key agreement (AKA) in accordance with some embodiments. FIG. 23 illustrates a second portion of the example primary authentication procedure representation 2200 for 5G AKA in accordance with some embodiments.

The procedure representation 2200 may include two Phases in 5G AKA/extensible authentication protocol (EAP)-AKA, a first phase 2202 and a second phase 2204. The first phase 2202 may include an initiation procedure (5G AKA/EAP-AKA). In the first phase 2202, a UE 2206 may send identification to a SEAF 2208 in virtual private local mobile network (VPLMN). The UE 2206 and the SEAF 2208 may be part of a serving network (SN). The SEAF 2208 may send an authentication request to an AUSF 2210 in HPLMN. The AUSF 2210 may be part of a home network (HN).

The second phase 2204 may include an authentication procedure (5G AKA). The second phase may initiate with a UDM/ARPF/SIDF 2212 generating an authentication vector (AV). In the second phase 2204, authentication vector generation, containing the RAND, AUTN, XRES*, and K_{AUSE} may be performed. The AUSF 2210 may derive the K_{SEAF} (anchor key) from K_{AUSE} and may send the challenge message to the SEAF 2208. At receipt of the RAND and AUTN, a USIM may compute a response RES and may return RES, CK, IK to the UE 2206. The ME may compute RES* from RES and may sends RES* back to the SEAF 2208. The SEAF 2208 may compute HRES* from the RES* and may compare the HRES* with HXRES*. If successful, the SEAF 2208 may forward RES* to the AUSF 2210. The AUSF 2210 may compare the received RES* with the stored XRES*. If successful, the authentication may be successful and the AUSF 2210 may indicate to the SEAF 2208.

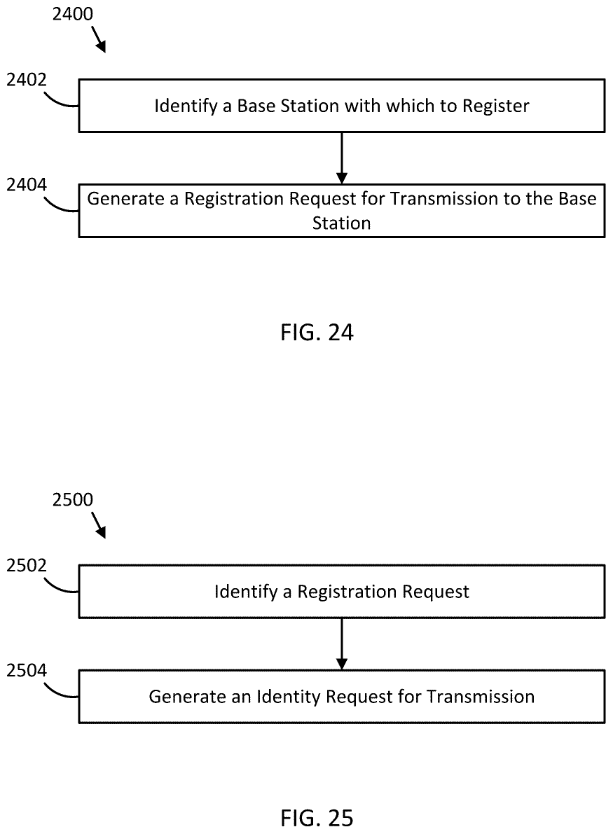

FIG. 24 illustrates an example procedure 2400 for generating a registration request in accordance with some embodiments. The procedure 2400 may be performed by a UE, such as the UE 104 (FIG. 1), the UE 106 (FIG. 1), and/or the UE 200 (FIG. 2).

The procedure 2400 may include identifying a base station with to register in 2402.

The procedure 2400 may include generating a registration request for transmission to the base station in 2404. The registration request may include an indication of whether a subscription concealed identifier (SUCI) enhancement is supported.

In some embodiments, the procedure 2400 may include deriving a physical access stratum key (K_phy_AS), and deriving an enhanced SUCI (SUCI-Enh) using the K_phy_AS. Further, the procedure 2400 may include enabling an enhanced SUCI (SUCI-Enh).

In some embodiments, the procedure 2400 may include generating an identity response for transmission, the identity response including an enhanced SUCI (SUCI-Enh). In some of these embodiments, the procedure 2400 may further include identifying an identity request that includes a SUCI update, wherein the identity response is generated based at least in part on identifying the identity request.

Any one or more of the operations in FIG. 24 may be performed in a different order than shown and/or one or more of the operations may be performed concurrently in embodiments. Further, it should be understood that one or more of the operations may be omitted from and/or one or more additional operations may be added to the procedure 2400 in other embodiments.

FIG. 25 illustrates an example procedure 2500 for implementing a SUCI enhancement in accordance with some embodiments. The procedure 2500 may be performed by a base station, such as the base station 108 (FIG. 1) and/or the network device 300 (FIG. 3).

The procedure 2500 may include identifying a registration request in 2502. For example, the base station may include identifying a registration request that includes an indication of whether subscription concealed identifier (SUCI) enhancement is supported.

The procedure 2500 may include generating an identity request for transmission in 2504. For example, the base station may generate an identity request for transmission, wherein the identity request includes a SUCI update. In some embodiments, the SUCI update includes an identity update, a key identifier (KID), or a subscription permanent identifier (SUPI).

In some embodiments, the procedure 2500 may include identifying an identity response that includes an enhanced SUCI (SUCI-Enh). In some of these embodiments, the procedure 2500 may include enabling the SUCI-Enh based at least in part on identifying the identity response that includes the SUCI-Enh.

Any one or more of the operations in FIG. 25 may be performed in a different order than shown and/or one or more of the operations may be performed concurrently in embodiments. Further, it should be understood that one or more of the operations may be omitted from and/or one or more additional operations may be added to the procedure 2500 in other embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example 1 may include a method comprising identifying a first transmission indicating a network preference for physical layer security (PLS) key enhancement, the first transmission received from an access and management function (AMF), and generating, for transmission to the AMF, a second transmission indicating a user equipment (UE) preference for the PLS key enhancement.

Example 2 may include the method of example 1, wherein the first transmission includes a non-access stratum (NAS) security mode command message, and wherein the second transmission includes a NAS security mode complete message.

Example 3 may include the method of example 1, wherein the first transmission includes a network PLS key enhancement preference information element that indicates the network preference for the PLS key enhancement.

Example 4 may include the method of example 3, wherein the network PLS key enhancement preference information element further indicates key refresh information and key lifetime information.

Example 5 may include the method of example 1, wherein the second transmission includes a UE PLS key enhancement preference information element that indicates the UE preference for the PLS key enhancement.

Example 6 may include the method of example 1, wherein the first transmission further indicates a network preference for whether to have separate physical keys for access stratum (AS) layer and non-access stratum (NAS) layer.

Example 7 may include the method of example 6, wherein the second transmission further indicates a UE preference for whether to have separate physical keys for AS layer and NAS layer.

Example 8 may include the method of example 1, further comprising determining that the PLS key enhancement is to be implemented, and generating an enhanced base station key based at least in part on a physical layer access stratum (AS) key, the enhanced base station key derived based at least in part on the determination that the PLS key enhancement is to be implemented.

Example 9 may include the method of example 1, further comprising determining that the PLS key enhancement is to be implemented, and generating an enhanced AMF key based at least in part on the determination that the PLS key enhancement is to be implemented.

Example 10 may include a method comprising generating, for transmission to a user equipment (UE), an access stratum (AS) security command mode message that indicates a network preference for physical layer security (PLS) key enhancement, and identifying an AS security mode complete message that indicates a UE preference for the PLS key enhancement.

Example 11 may include the method of example 10, further comprising generating a message, for transmission to an access and mobility management function (AMF), that includes the UE preference for the PLS key enhancement, and identifying an AMF preference for the PLS key enhancement, the AMF preference for the PLS key enhancement received from the AMF.

Example 12 may include the method of example 11, further comprising determining that the AMF preference for the PLS key enhancement indicates that the PLS key enhancement is to be implemented, and generating an enhanced base station key based at least in part on a physical layer AS key.

Example 13 may include the method of example 10, wherein the AS security command mode message includes a network PLS key enhancement preference information element that indicates the network preference for the PLS key enhancement.

Example 14 may include the method of example 13, wherein the network PLS key enhancement preference information element further indicates a network preference for whether separate physical keys are to be used for an access stratum (AS) layer and an NAS layer.

Example 15 may include the method of example 13, wherein the network PLS key enhancement preference information element further indicates key refresh information and key lifetime information for one or more keys related to the PLS key enhancement.

Example 16 may include a method comprising determining that a physical layer security (PLS) key enhancement is to be implemented based at least in part on information from an access and mobility management function (AMF), generating one or more PLS keys based at least in part on the determination that the PLS key enhancement is to be implemented, generating an enhanced base station key based at least in part on the one or more PLS keys, and generating an enhanced AMF key based at least in part on the one or more PLS keys.

Example 17 may include the method of example 16, wherein generating the one or more PLS keys includes generating a single PLS key for an access stratum (AS) layer and a non-access stratum (NAS) layer, wherein the enhanced base station key is generated based at least in part on the single PLS key, and wherein the enhanced AMF key is generated based at least in part on the single PLS key.

Example 18 may include the method of example 16, wherein generating the one or more PLS keys includes generating a first PLS key for an access stratum (AS) layer and a second PLS key for a non-access stratum (NAS) layer, wherein the enhanced base station key is generated based at least in part on the first PLS key, and wherein the enhanced AMF key is generated based at least in part on the second PLS key.

Example 19 may include the method of example 16, further comprising identifying a received network PLS key enhancement preference information element, wherein the received network PLS key enhancement preference information element includes the information for determining that the PLS key enhancement is to implemented.

Example 20 may include the method of example 19, wherein the received network PLS key enhancement preference information element includes a first field that indicates a network preference for the PLS key enhancement and a second field that indicates a network preference for a number of the one or more PLS keys.

Example 21 may include a method, comprising identifying a base station with which to register, and generating a registration request for transmission to the base station, the registration request including an indication of whether a subscription concealed identifier (SUCI) enhancement is supported.

Example 22 may include the method of example 21, further comprising deriving a physical access stratum key (K_phy_AS), and deriving an enhanced SUCI (SUCI-Enh) using the K_phy_AS.

Example 23 may include the method of example 21, further comprising generating an identity response for transmission, the identity response including an enhanced SUCI (SUCI-Enh).

Example 24 may include the method of example 23, further comprising identifying an identity request that includes a SUCI update, wherein the identity response is generated based at least in part on identifying the identity request.

Example 25 may include the method of example 21, further comprising enabling an enhanced SUCI (SUCI-Enh).

Example 26 may include the method of any of examples 21-25, further comprising one or more of the features of any of examples 1-9 and 16-20.

Example 27 may include a method, comprising identifying a registration request that includes an indication of whether subscription concealed identifier (SUCI) enhancement is supported, and generating an identity request for transmission, wherein the identity request includes a SUCI update.

Example 28 may include the method of example 27, wherein the SUCI update includes an identity update, a key identifier (KID), or a subscription permanent identifier (SUPI).

Example 29 may include the method of example 27, further comprising identifying an identity response that includes an enhanced SUCI (SUCI-Enh).

Example 30 may include the method of example 29, further comprising enabling the SUCI-Enh based at least in part on identifying the identity response that includes the SUCI-Enh.

Example 31 may include the method of any of examples 27-30, further comprising one or more of the features of any of examples 10-15.

Example 32 may include an apparatus comprising means to perform one or more elements of a method described in or related to any of examples 1-31, or any other method or process described herein.

Example 33 may include one or more non-transitory computer-readable media comprising instructions to cause an electronic device, upon execution of the instructions by one or more processors of the electronic device, to perform one or more elements of a method described in or related to any of examples 1-31, or any other method or process described herein.

Example 34 may include an apparatus comprising logic, modules, or circuitry to perform one or more elements of a method described in or related to any of examples 1-31, or any other method or process described herein.

Example 35 may include a method, technique, or process as described in or related to any of examples 1-31, or portions or parts thereof.

Example 36 may include an apparatus comprising: one or more processors and one or more computer-readable media comprising instructions that, when executed by the one or more processors, cause the one or more processors to perform the method, techniques, or process as described in or related to any of examples 1-31, or portions thereof.

Example 37 may include a signal as described in or related to any of examples 1-31, or portions or parts thereof.

Example 38 may include a datagram, information element, packet, frame, segment, PDU, or message as described in or related to any of examples 1-31, or portions or parts thereof, or otherwise described in the present disclosure.

Example 39 may include a signal encoded with data as described in or related to any of examples 1-31, or portions or parts thereof, or otherwise described in the present disclosure.

Example 40 may include a signal encoded with a datagram, IE, packet, frame, segment, PDU, or message as described in or related to any of examples 1-31, or portions or parts thereof, or otherwise described in the present disclosure.

Example 41 may include an electromagnetic signal carrying computer-readable instructions, wherein execution of the computer-readable instructions by one or more processors is to cause the one or more processors to perform the method, techniques, or process as described in or related to any of examples 1-31, or portions thereof.

Example 42 may include a computer program comprising instructions, wherein execution of the program by a processing element is to cause the processing element to carry out the method, techniques, or process as described in or related to any of examples 1-31, or portions thereof.

Example 43 may include a signal in a wireless network as shown and described herein.

Example 44 may include a method of communicating in a wireless network as shown and described herein.

Example 45 may include a system for providing wireless communication as shown and described herein.

Example 46 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory computer-readable media having instructions, that when executed, cause processing circuitry to:
identify a first transmission indicating a network preference for physical layer security (PLS) key enhancement, the first transmission received from an access and management function (AMF); and
generate, for transmission to the AMF, a second transmission indicating a user equipment (UE) preference for the PLS key enhancement.

2. The one or more non-transitory computer-readable media of claim 1, wherein the first transmission includes a non-access stratum (NAS) security mode command message, and wherein the second transmission includes a NAS security mode complete message.

3. The one or more non-transitory computer-readable media of claim 1, wherein the first transmission includes a network PLS key enhancement preference information element that indicates the network preference for the PLS key enhancement.

4. The one or more non-transitory computer-readable media of claim 3, wherein the network PLS key enhancement preference information element further indicates key refresh information and key lifetime information.

5. The one or more non-transitory computer-readable media of claim 1, wherein the second transmission includes a UE PLS key enhancement preference information element that indicates the UE preference for the PLS key enhancement.

6. The one or more non-transitory computer-readable media of claim 1, wherein the first transmission further indicates a network preference for whether to have separate physical keys for access stratum (AS) layer and non-access stratum (NAS) layer.

7. The one or more non-transitory computer-readable media of claim 6, wherein the second transmission further indicates a UE preference for whether to have separate physical keys for AS layer and NAS layer.

8. The one or more non-transitory computer-readable media of claim 1, wherein the instructions, when executed, further cause the processing circuitry to:
determine that the PLS key enhancement is to be implemented; and
generate an enhanced base station key based at least in part on a physical layer access stratum (AS) key, the enhanced base station key derived based at least in part on the determination that the PLS key enhancement is to be implemented.

9. The one or more non-transitory computer-readable media of claim 1, wherein the instructions, when executed, further cause the processing circuitry to:
determine that the PLS key enhancement is to be implemented; and
generate an enhanced AMF key based at least in part on the determination that the PLS key enhancement is to be implemented.

10. A method comprising:
generating, for transmission to a user equipment (UE), an access stratum (AS) security mode command message that indicates a network preference for physical layer security (PLS) key enhancement; and
identifying an AS security mode complete message that indicates a UE preference for the PLS key enhancement.

11. The method of claim 10, further comprising:
generating a message, for transmission to an access and mobility management function (AMF), that includes the UE preference for the PLS key enhancement; and
identifying an AMF preference for the PLS key enhancement, the AMF preference for the PLS key enhancement received from the AMF.

12. The method of claim 11, further comprising:
determining that the AMF preference for the PLS key enhancement indicates that the PLS key enhancement is to be implemented; and
generating an enhanced base station key based at least in part on a physical layer AS key.

13. The method of claim 10, wherein the AS security mode command message includes a network PLS key enhancement preference information element that indicates the network preference for the PLS key enhancement.

14. The method of claim 13, wherein the network PLS key enhancement preference information element further indicates a network preference for whether separate physical keys are to be used for an AS layer and a non-access stratum (NAS) layer.

15. The method of claim 13, wherein the network PLS key enhancement preference information element further indicates key refresh information and key lifetime information for one or more keys related to the PLS key enhancement.

16. An apparatus comprising:
processing circuitry to:
determine that a physical layer security (PLS) key enhancement is to be implemented based at least in part on information from an access and mobility management function (AMF);
generate one or more PLS keys based at least in part on the determination that the PLS key enhancement is to be implemented;
generate an enhanced base station key based at least in part on the one or more PLS keys; and
generate an enhanced AMF key based at least in part on the one or more PLS keys; and
interface circuitry coupled with the processing circuitry, the interface circuitry to enable communication.

17. The apparatus of claim 16, wherein to generate the one or more PLS keys includes to generate a single PLS key for an access stratum (AS) layer and a non-access stratum (NAS) layer, wherein the enhanced base station key is generated based at least in part on the single PLS key, and wherein the enhanced AMF key is generated based at least in part on the single PLS key.

18. The apparatus of claim 16, wherein to generate the one or more PLS keys includes to generate a first PLS key for an access stratum (AS) layer and a second PLS key for a non-access stratum (NAS) layer, wherein the enhanced base station key is generated based at least in part on the first PLS key, and wherein the enhanced AMF key is generated based at least in part on the second PLS key.

19. The apparatus of claim 16, wherein the processing circuitry is further to:
identify a received network PLS key enhancement preference information element, wherein the received network PLS key enhancement preference information element includes the information for determining that the PLS key enhancement is to implemented.

20. The apparatus of claim 19, wherein the received network PLS key enhancement preference information element includes a first field that indicates a network preference for the PLS key enhancement and a second field that indicates a network preference for a number of the one or more PLS keys.
